(19) United States
(12) Patent Application Publication
(10) Pub. No.: US 2016/0307171 A1
(43) Pub. Date: Oct. 20, 2016

(54) TRANSACTION EQUIPMENT AND TRANSACTION PROCESSING METHOD

(71) Applicant: PANASONIC INTELLECTUAL PROPERTY MANAGEMENT CO., LTD., Osaka (JP)

(72) Inventor: Ichiro HAGA, Fukuoka (JP)

(73) Assignee: PANASONIC INTELLECTUAL PROPERTY MANAGEMENT CO., LTD., Osaka (JP)

(21) Appl. No.: 15/086,271

(22) Filed: Mar. 31, 2016

(30) Foreign Application Priority Data
Apr. 17, 2015 (JP) 2015-085451

(51) Int. Cl. G06Q 20/10; G06Q 20/20; H04W 76/02; G06Q 10/10

(52) U.S. Cl. CPC G06Q 20/10; G06Q 10/105; G06Q 20/20; H04W 76/02

(57) ABSTRACT

Transaction equipment includes an application controller that is capable of executing at least one of a settlement application and a business application, a radio communicator that performs communication with at least one peripheral equipment used in the settlement application or the business application or a docking device to which at least one peripheral equipment is connected, and a link establisher that selects any one of a plurality of docking device, as a first docking device, based on reception qualities of signals transmitted from the plurality of docking devices, and establishes a radio communication link with at least one peripheral equipment connected to the first docking device. When the transaction equipment is operated in cooperation with peripheral equipment used in at least one target procedure of a merchandise registration process and a settlement process, it is possible to allow the transaction equipment to cooperate with peripheral equipment to be used with a simple operation without requiring a complicated setting operation, and degradation in customer service quality is prevented.

### BACKGROUND OF THE INVENTION

1. Field of the Invention

The present disclosure relates to transaction equipment and a transaction processing method used to perform at least one procedure of a merchandise registration process and a settlement process in a commercial transaction.

2. Description of the Related Art

In a store (for example, a convenience store), a merchandise registration process of registering merchandise items as sales targets in a commercial transaction (for example, merchandise sales, the same applies later) in a POS (Point Of Sales) terminal such as cash register is generally performed. For example, the POS terminal is a stationary type as in a POS terminal with a fixed scanner which is described in Japanese Patent Unexamined Publication No. 04-279995, and is fixedly provided in, for example, an exclusive counter of a store in many cases. In the POS terminal with a fixed scanner which is described in Japanese Patent Unexamined Publication No. 04-279995, a fixed scanner is supported by a supporting stand of the POS terminal through support means so as to be moved in upward and downward directions and forward, backward, leftward and rightward directions and so as to be tilted and rotated. In the merchandise registration process, a salesperson directly performs a touch input of merchandise items as sales targets on a touch panel provided at the POS terminal without using the fixed scanner, or performs a touch input of merchandise items displayed on a touch panel of portable transaction equipment in which an application for merchandise registration is installed so as to be executable in some cases.

For example, when a settlement process using a card (for example, a credit card) is performed in order to pay the amount of money required in the commercial transaction, in a case where an authorization inquiry about a owner of the card is performed and a response indicating that there are no particular problems with the authorization is obtained, the POS terminal transmits sales information to a settlement server (for example, a settlement center device operated by a settlement center or a settlement relay center device operated by a settlement relay center) connected to the POS terminal via a communication network (sales registration). In the settlement process, portable transaction equipment (for example, a settlement terminal) in which an application for a settlement process is installed so as to be executable and communication can be performed with the settlement server is used instead of the POS terminal in some cases.

For example, peripheral equipments such as a keyboard for inputting items or quantities of merchandises, a printer for printing a receipt related to the sales of the merchandises, a drawer for storing cash, and a display for displaying a sales amount of money to a customer are provided in, or are connected to the POS terminal provided in the store or near the POS terminal. Since the POS terminal is provided on the exclusive counter in the store, in order to improve operation convenience when the procedure of the merchandise registration process or the settlement process of the salesperson is performed, it is preferable to distinguish between a case where the portable transaction equipment and the peripheral equipment are used in cooperation with each other and a case where the transaction equipment is independently used.

A plurality of checkout counters are provided in order to reduce a processing time of a transaction (for example, merchandise registration, settlement, or sales registration) in many cases when many purchasers (customers) stand in line in a store. The peripheral equipments are respectively provided in the checkout counters according to various transaction classifications, and are connected to POS terminals. In this case, when portable transaction equipment and the peripheral equipment are used in cooperation with each other or the transaction equipment is independently used, if it is difficult to use the peripheral equipment which is geographically present in the proximity of the transaction equipment, it is necessary to set preset peripheral equipment as being unusable by the transaction equipment once and to set a target peripheral equipment as being usable by the transaction equipment again. Accordingly, it takes time to respond the purchasers, and thus, customer service quality is degraded. Thus, since the purchaser may lessen merchandise desired to be purchased within a time limit or may give up the purchase, the purchaser's eagerness to purchase is degraded. That is, the salesperson loses the sales opportunity of merchandise, and it is difficult to expect a rise in sales. Especially in a store that handles card settlement, there is a difficulty with a rise in fee income of a service provider such as an acquirer related to card settlement.

### SUMMARY OF THE INVENTION

An object of the present disclosure is to prevent degradation in customer service quality by allowing transaction equipment to cooperate with peripheral equipment to be used with a simple operation without requiring a complicated setting operation when the transaction equipment is operated in cooperation with peripheral equipment used in at least one target procedure of a merchandise registration process and a settlement process.

According to the present disclosure, there is provided transaction equipment including: an application controller that is capable of executing at least one of a settlement application and a business application; a radio communicator that performs communication with at least one peripheral equipment used in the settlement application or the business application or a docking device to which the at least one peripheral equipment is connected; and a link establisher that selects any one of a plurality of docking devices, as a first docking device, based on reception qualities of signals transmitted from the plurality of docking devices, and establishes a radio communication link with the least one peripheral equipment connected to the first docking device.

According to the present disclosure, there is provided transaction equipment including: an application controller that is capable of executing at least one of a settlement application and a business application; a radio communicator that performs communication with peripheral equipments belonging to a specific classification used in the settlement application or the business application or a docking device to which the peripheral equipment belonging to the specific classification is connected; and a link establisher that selects any one of the peripheral equipments belonging to the specific classification, as first peripheral equipment, based on reception qualities of signals transmitted from the peripheral equipments belonging to the specific classification, which are connected to a plurality of the docking devices, and establishes a radio communication link with the first peripheral equipment.

According to the present disclosure, there is provided transaction equipment including: an application controller that is capable of executing at least one of a settlement application and a business application; a radio communicator that performs communication with at least one peripheral equipment used in the settlement application or the business application; an attachment and separation detector that detects the attachment and separation of the transaction equipment to and from the docking device to which the at least one peripheral equipment is connected; and a link establisher that establishes a radio communication link with the at least one peripheral equipment. The link establisher establishes the link with the at least one peripheral equipment connected to the docking device in a case where the attachment of the transaction equipment to the docking device is detected by the attachment and separation detector.

According to the present disclosure, there is provided transaction equipment including: an application controller that is capable of executing at least one of a settlement application and a business application; a radio communicator that performs communication with at least one peripheral equipment used in the settlement application or the business application; a proximity detector that detects the proximity of the transaction equipment to the docking device to which the at least one peripheral equipment is connected; and a link establisher that establishes a radio communication link with the at least one peripheral equipment. The link establisher establishes the link with the at least one peripheral equipment connected to the docking device in a case where the proximity of the transaction equipment to the docking device is detected by the proximity detector.

According to the present disclosure, there is provided a transaction processing method in transaction equipment capable of executing at least one of a settlement application and a business application. The transaction processing method includes: receiving signals transmitted from a plurality of docking devices to which at least one peripheral equipment used in the settlement application or the business application is connected; selecting any one of the docking devices, as a first docking device, based on reception qualities of the signals transmitted from the plurality of docking devices; and establishing a radio communication link with the at least one peripheral equipment connected to the selected first docking device.

According to the present disclosure, there is provided a transaction processing method in transaction equipment capable of executing at least one of a settlement application and a business application. The transaction processing method includes: receiving signals transmitted from a plurality of peripheral equipments belonging to a specific classification, which are used in the settlement application or the business application; selecting any one of the peripheral equipments belonging to the specific classification, as first peripheral equipment, based on reception qualities of the signals transmitted from the plurality of peripheral equipments belonging to the specific classification; and establishing a radio communication link with the selected first peripheral equipment.

According to the present disclosure, there is provided a transaction processing method in transaction equipment capable of executing at least one of a settlement application and a business application. The transaction processing method includes: detecting the attachment and separation of the transaction equipment to and from a docking device to which at least one peripheral equipment used in the settlement application or the business application is connected; and establishing a radio communication link with the at least one peripheral equipment connected to the docking device in a case where the attachment of the transaction equipment to the docking device is detected.

According to the present disclosure, there is provided a transaction processing method in transaction equipment capable of executing at least one of a settlement application and a business application. The transaction processing method includes: detecting the proximity of the transaction equipment to the docking device to which at least one peripheral equipment used in the settlement application or the business application is connected; and establishing a radio communication link with the at least one peripheral equipment connected to the docking device in a case where the proximity of the transaction equipment to the docking device is detected.

According to the present disclosure, it is possible to prevent degradation in customer service quality by allowing transaction equipment to cooperate with peripheral equipment to be used with a simple operation without requiring a complicated setting operation when the transaction equipment is operated in cooperation with peripheral equipment used in at least one target procedure of a merchandise registration process and a settlement process.

### BRIEF DESCRIPTION OF DRAWINGS

FIG. 1 is a diagram showing an example of the system configuration of a transaction processing system of the present exemplary embodiment;

FIG. 2 is a diagram for describing an example of a state in which transaction equipment is attached to or is detached from a docking device;

FIG. 3 is a diagram showing an example of a state in which the transaction equipment is attached to the docking device;

FIG. 4A is a diagram showing an example of the docking device in which an upper supporting part is rotated around a lower supporting part through a hinge in a tilt direction (arrow v1 direction);

FIG. 4B is a diagram showing an example of the docking device in which a holder rotation part rotates an equipment holder in an arrow v2 direction about 90 degrees from the position in the state of FIG. 4A;

FIG. 4C is a diagram showing an example of the docking device in which a rotatable pedestal is rotated in a panning direction (arrow v3 direction) from the position in the state of FIG. 3;

FIG. 5 is a diagram showing an example of the hardware configuration of the transaction equipment of the present exemplary embodiment;

FIG. 6 is a diagram showing an example of the hardware configuration of the docking device of the present exemplary embodiment;

FIG. 7A is a diagram showing a first example in which an operation screen of a card settlement application executable in the transaction equipment is displayed on a touch panel of the transaction equipment;

FIG. 7B is a diagram showing a second example in which the operation screen of the card settlement application executable in the transaction equipment is displayed on the touch panel of the transaction equipment;

FIG. 8 is a diagram showing an example in which an operation screen of a merchandise registration application executable in the transaction equipment is displayed on the touch panel of the transaction equipment;

FIG. 9 is a flowchart for describing an example of an operation procedure related to communication link establishment with peripheral equipment when the transaction equipment of the present exemplary embodiment is attached to or is held near the docking device;

FIG. 10 is a flowchart for describing an example of an operation procedure related to communication link establishment depending on reception electric field intensity when a signal is received between the transaction equipment of the present exemplary embodiment and the docking device;

FIG. 11 is a flowchart for describing an example of an operation procedure in which the transaction equipment of the present exemplary embodiment establishes a communication link with fixedly assigned peripheral equipment;

FIG. 12 is a flowchart for describing an example of an operation procedure when the operation procedure shown in FIG. 9 and the operation procedure shown in FIG. 11 are performed in parallel;

FIG. 13 is a flowchart for describing an example of an operation procedure when the operation procedure shown in FIG. 10 and the operation procedure shown in FIG. 11 are performed in parallel;

FIG. 14 is a flowchart for describing an example of an operation procedure related to communication link establishment depending on reception electric field intensity when a signal is received between the transaction equipment of the present exemplary embodiment and the peripheral equipment;

FIG. 15 is a flowchart for describing an example of an operation procedure of the transaction equipment of the present exemplary embodiment in a case where the transaction equipment requests a receipt printer an example of the peripheral equipment to print;

FIG. 16 is a table showing an example of the relationship between a common printer and a docking device and peripheral equipment constituting a docking group;

FIG. 17 is a table showing an example of the docking device in which a communication link with the transaction equipment is established;

FIG. 18 is a table showing an example of at least one peripheral equipment in which a communication link with the transaction equipment is established; and

FIG. 19 is a schematic diagram showing an example of the layout of the common printer and the docking group provided within a store.

### DETAILED DESCRIPTION OF THE PREFERRED EMBODIMENT

Hereinafter, an exemplary embodiment (hereinafter, referred to as “present exemplary embodiment”) in which transaction equipment, a transaction processing method, and a program according to the present disclosure are specifically disclosed will be described in detail by appropriately referring to the drawings. Unnecessary descriptions may be omitted in some cases. For example, the detailed descriptions of the already well-known matters or the redundant descriptions of substantially the same configurations may be omitted in some cases. Such omissions are performed in order to allow a person skilled in the art to easily understand the present disclosure by preventing the following description from becoming unnecessarily redundant. The accompanying drawings and the following descriptions are provided to help a person skilled in the art fully understand the present disclosure, and thereby are not intended to limit the subject matter described in the claims.

### System Configuration of Transaction Processing System

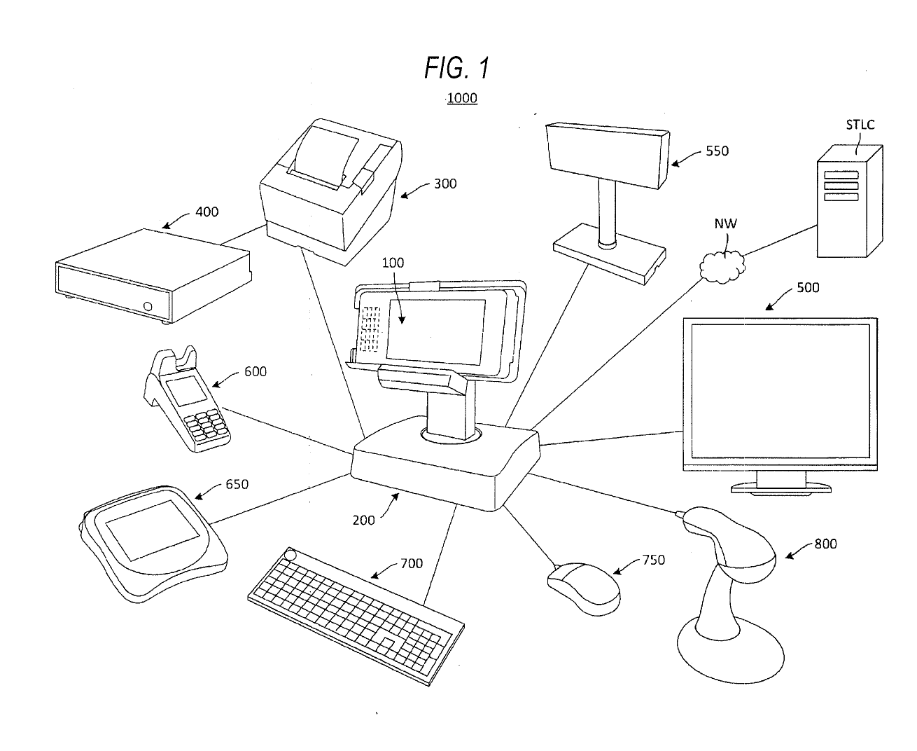

Initially, the system configuration of transaction processing system 1000 of the present exemplary embodiment will be described with reference to FIG. 1. FIG. 1 is a diagram showing an example of the system configuration of transaction processing system 1000 of the present exemplary embodiment. For example, transaction processing system 1000 shown in FIG. 1 is provided in a store such as a convenience store or a supermarket, and includes transaction equipment 100, docking device 200, receipt printer 300, cash drawer 400, external display 500, customer display 550, PINPAD 600, sign pad 650, keyboard 700, mouse 750, and barcode reader 800. Hereinafter, at least one of receipt printer 300, cash drawer 400, external display 500, customer display 550, PINPAD 600, sign pad 650, keyboard 700, mouse 750, and barcode reader 800 is referred to as “peripheral equipment” in some cases.

In transaction processing system 1000, docking device 200 on which transaction equipment 100 is mounted is connected to a settlement server (for example, a settlement relay center device operated by third party processor or a settlement center device operated by an issuer or an acquirer, to be described below) STLC in a settlement application which is installed to be executable in transaction equipment 100 via network NW.

Network NW is, for example, an intranet or the Internet. For example, the intranet is a wireless or wired local area network within the store in which transaction equipment 100 is provided. The internet is a network connected using the wireless network or the wired network as an interface. For example, the wireless network is a wireless LAN (Local Area Network), a wireless WAN (Wide Area Network), 3G, HSPA (High Speed Packet Access), LTE (Long Term Evolution), or WiGig (Wireless Gigabit). For example, the wired network is IEEE802.3/Ethernet (registered trademark). For example, network NW may be a wide area network established using 3G, HSPA or LTE, or may be a network established using an existing telephone line. Network NW may be established using another connection network such as an internet connection network through an access point which is a spot of Wifi (registered trademark). The Internet may be established using another connection network such as a dedicated line or an intranet.

The settlement relay center device is a server device for a settlement relay process in a third party processor (that is, a company which is requested a business from an issuer (a card issuing company) or an acquirer (a company that invites member stores which specific card transaction, and manages sales information based on the card transaction of the member store), and relays a settlement process from each member store). The settlement relay center device receives a request for sales registration or an authorization inquiry for the settlement process of a commercial transaction from transaction equipment 100 via network NW, inquires about the determination of whether or not to grant authorization by the settlement center device, and requests the processing of the sales registration by the settlement center device.

For example, settlement center device STLC2 is a server device for a settlement process which is operated by the issuer or the acquirer that directly fulfills member-store contracts with the member stores. The settlement center device sends the authorization result, the determination result of the authorization inquiry or the processing result of the sales registration to transaction equipment 100 through the settlement relay center device in response to the inquiry about the determination from the settlement relay center device. Settlement center device STLC2 may receive a request for the sales registration or the authorization inquiry of the settlement process of the commercial transaction from transaction equipment 100 via network NW, may perform the determination of whether or not to authorize, and may directly send the processing result of the sales registration or the determination result of the authorization inquiry to transaction equipment 100.

For example, transaction equipment 100 is a settlement terminal device, such as a tablet terminal which is easily held with one hand or both hands by a salesperson, which includes a portable housing and in which at least one of a settlement application and a general-purpose business application (for example, a merchandise registration application or a stock management application) required for the business in the store where transaction equipment 100 is provided is installed so as to be executable. Hereinafter, the transaction equipment may be referred to as MPOS (Mobile Point Of Sales) in some cases. Transaction equipment 100 receives information (settlement information) regarding various items related to the settlement process of a transaction using a card through touch panels TP2 and TP1 by a user (for example, a salesperson or a customer), and reads a card number and an expiration date of the card.

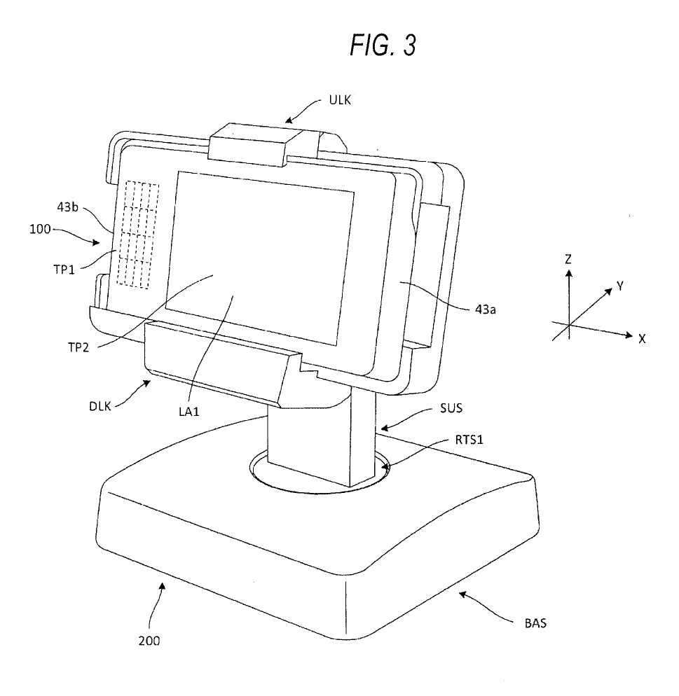

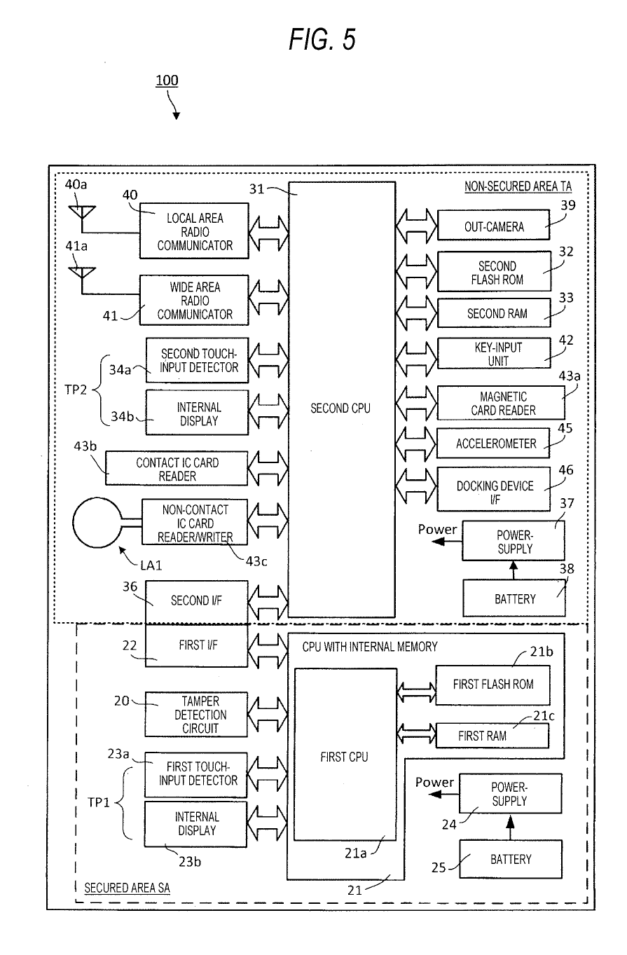

In a case where transaction equipment is attached to docking device 200 (see FIG. 3), transaction equipment (MPOS) 100 performs communication related to the settlement process of the commercial transaction using the card (for example, an IC credit card, the same applies later) with settlement server STLC (for example, the settlement relay center device or the settlement center device) via docking device 200 and network NW. Even in a case where transaction equipment is detached from docking device 200, transaction equipment 100 may perform the communication related to the settlement process of the commercial transaction using the card with settlement server STLC via the network. The specific configuration of transaction equipment 100 will be described with reference to FIG. 5.

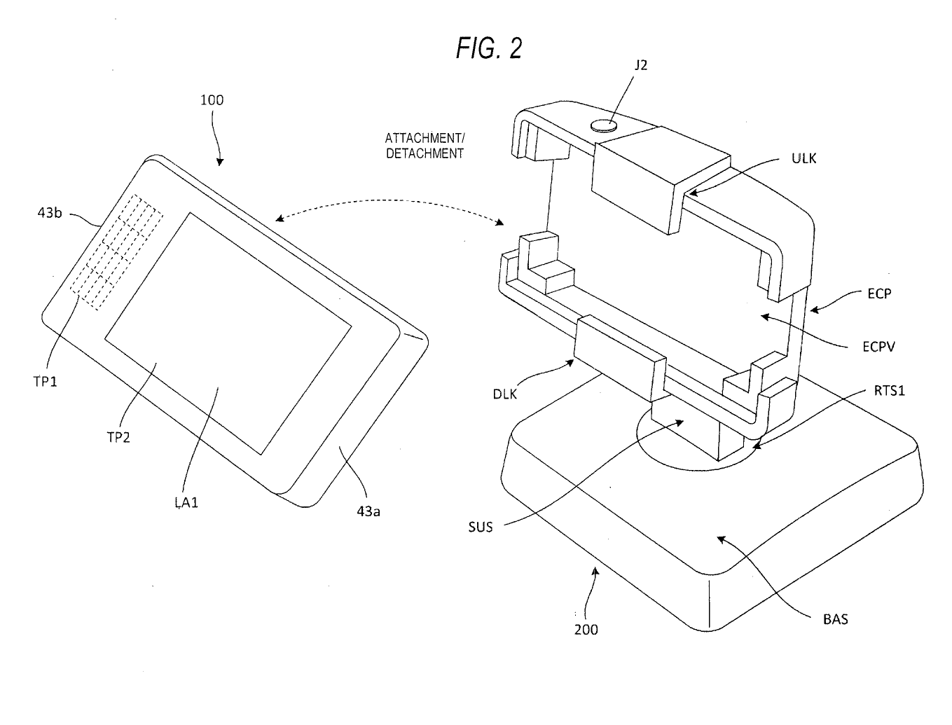

Docking device 200 is connected to at least one peripheral equipment (see FIG. 1) used in at least one of the settlement application and the general-purpose application installed in transaction equipment 100, and allows transaction equipment 100 to be attached and detached (see FIGS. 2 and 3).

Receipt printer 300 as an example of the peripheral equipment is connected to docking device 200 and cash drawer 400, and prints predetermined receipts by using print data regarding the predetermined receipts (for example, a customer receipt and a store receipt) output from docking device 200 in a case where the settlement related to the commercial transaction is normally ended. For example, in a case where the receipts are printed, receipt printer 300 switches a switch built in cash drawer 400 from an OFF state (a locked state) to an ON state (an unlocked state), and pushes cash drawer 400 in an opening direction, in response to a control signal from transaction equipment 100. In a case where transaction equipment 100 is attached to and is connected to docking device 200, the control signal is a signal which is transmitted from transaction equipment 100 and is received by docking device 200, and is transmitted to receipt printer 300 through docking device 200.

Cash drawer 400 as an example of the peripheral equipment is connected to only receipt printer 300, and strictly stores cash possessed in the store where transaction processing system 1000 is provided.

External display 500 as an example of the peripheral equipment is a display device which is connected to docking device 200 and has a display area greater than that internal display 34b of transaction equipment 100. External display 500 may be a touch panel capable of detecting a touch input of the salesperson or the customer.

Customer display 550 as an example of the peripheral equipment is a display device which is connected to docking device 200 and has a display area having a predetermined size, and displays, for example, a sales amount of money (settlement amount of money) related to the commercial transaction of the customer in a direction in which the information can be easily seen by the customer. Customer display 550 may be a touch panel capable of detecting a touch panel of the salesperson or the customer.

PINPAD 600 as an example of the peripheral equipment is an input device which is connected to docking device 200 and allows the customer to input a PIN (Personal Identification Number) as authentication information for authenticating the customer as a legitimate owner of the card during the execution of the settlement application using the card.

Sign pad 650 as an example of the peripheral equipment is an input device which is connected to docking device 200 and allows the customer to input electronic data regarding a handwritten signature as authentication information for authenticating the customer as a legitimate owner of the card during the execution of the settlement application using the card.

Keyboard 700 as an example of the peripheral equipment is connected to docking device 200, and is used by the salesperson in order to input characters or numerals on an operation screen of an application executable in transaction equipment 100.

Mouse 750 as an example of the peripheral equipment is connected to docking device 200, and is used by the salesperson in order to select a specific item on an operation screen of an application executable in transaction equipment 100.

Barcode reader 800 as an example of the peripheral equipment is connected to docking device 200, and is used by the salesperson in order to read a barcode assigned to a merchandise or a coupon as a target of the commercial transaction.

Attachment and Detachment of Transaction Equipment to and from Docking Device

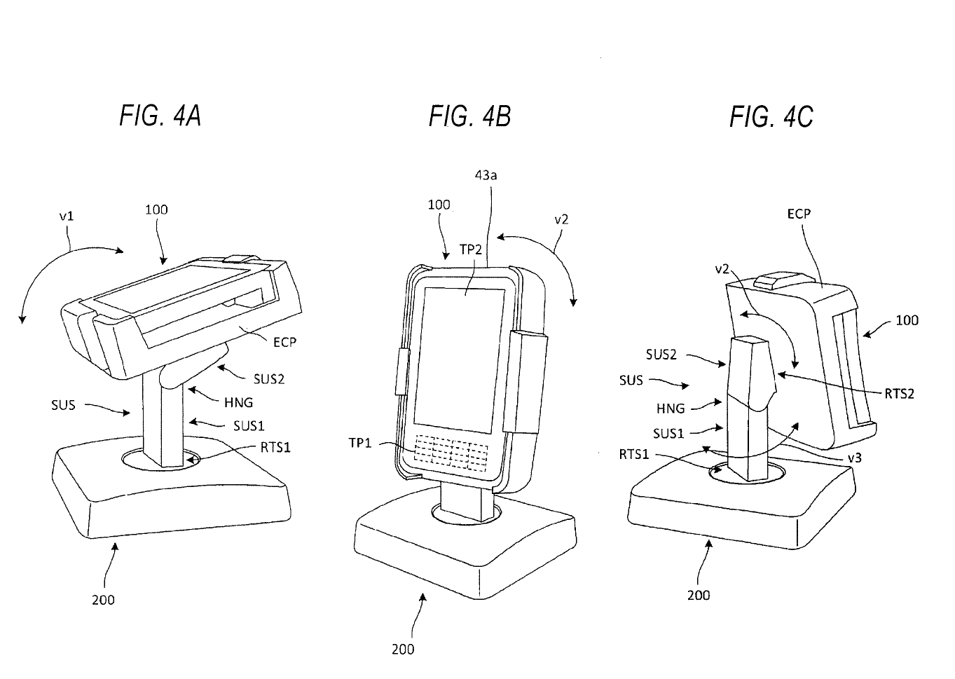

Hereinafter, the attachment and detachment of transaction equipment 100 to and from docking device 200 will be described with reference to FIGS. 2, 3, and 4A to 4C, FIG. 2 is a diagram for describing an example of a state in which transaction equipment 100 is attached to and is detached from docking-device 200. FIG. 3 is a diagram showing an example of a state in which transaction equipment 100 is attached to docking device 200. FIG. 4A is a diagram showing an example of docking device 200 in which upper supporting part SUS2 is rotated around lower supporting part SUS1 in a tilt direction (arrow v1 direction) through hinge HNG. FIG. 4B is a diagram showing docking device 200 in which holder rotation part RTS2 rotates equipment holder ECP in an arrow v2 direction about 90 degrees from the position in the state of FIG. 4A. FIG. 4C is a diagram showing an example of docking device 200 in which rotatable pedestal RTS1 is rotated in a panning direction (arrow v3 direction) from the position in the state of FIG. 3.

For example, docking device 200 is disposed in a predetermined position of a checkout counter of the store, and includes equipment holder ECP supported by supporting part SUS which is erected upward from columnar rotatable pedestal RTS1, which is provided in a near central position of square-columnar fixing pedestal BAS, in a vertical direction. Rotatable pedestal RTS1 is rotated around fixing pedestal BAS about 180 degrees (see FIG. 4C). Equipment holder ECP includes upper locking part ULK, and lower locking part DLK, and holds and locks transaction equipment 100 in equipment holding space ECPV formed between upper locking part ULK and lower locking part DLK so as to expose transaction equipment 100. Locking part J2 is formed in upper locking part ULK, and if transaction equipment 100 is attached in equipment holding space ECPV of docking device 200 and then is locked by a tool such as a driver, upper locking part ULK and lower locking part DLK lock transaction equipment 100 so as to sandwich transaction equipment in both directions of an upward direction and a downward direction. Thus, transaction equipment 100 is physically attached to docking device 200.

In the case where the transaction equipment 100 is attached to docking device 200 (see FIG. 3) and in the case where the transaction equipment 100 is detached from the docking device (see FIG. 2), for example, transaction equipment 100 can receive an input operation of the salesperson on touch panel TP2 provided in non-secured area TA (see FIG. 5), and can receive an input operation of the customer on touch panel TP1 provided in secured area SA (see FIG. 5).

In transaction equipment 100, magnetic card reader 43a is provided on a side surface of the housing of transaction equipment 100 close to non-secured area TA, in a transverse direction, and contact IC card reader 43b is provided on a side surface of the housing of transaction equipment 100 close to secured area SA in a transverse direction. Loop antenna LA1 connected to non-contact IC card reader/writer 43c, to be described below, is provided in a portion of the housing of transaction equipment 100 close to non-secured area TA (that is, a portion which is substantially parallel to touch panel TP2). In the case where the transaction equipment 100 is attached to docking device 200 (see FIG. 3) and in the case where the transaction equipment 100 is detached from the docking device (see FIG. 2), transaction equipment 100 can read a magnetic card in magnetic card reader 43a, can read a contact IC card in contact IC card reader 43b, and can read a non-contact IC card approaching near loop antenna LA1 in non-contact IC card reader/writer 43c through the operation of the salesperson.

As shown in FIGS. 4A to 4C, docking device 200 to which transaction equipment 100 is attached can be rotated in various directions. For example, as shown in FIG. 4A, in docking device 200, upper supporting part SUS2 can be rotated around lower supporting part SUS1 through hinge HNG in the tilt direction (arrow v1 direction). Supporting part SUS shown in FIG. 2 or 3 is configured such that lower supporting part SUS1 which is erected from rotatable pedestal RTS1, hinge HNG which rotates upper supporting part SUS2 around lower supporting SUS1 in the tilt direction, and upper supporting part SUS2 which supports equipment holder ECP are sequentially connected (see FIG. 4A). Thus, the salesperson or the customer can easily input the operations on touch panels TP2 and TP1 by rotating docking device 200 such that touch panels TP2 and TP1 of transaction equipment 100 face a ceiling surface of the store.

As shown in FIG. 4B, in docking device 200, holder rotation part RTS2 (see FIG. 4C) can rotate equipment holder ECP in the arrow v2 direction about 90 degrees from the position in the state of FIG. 4A. Thus, since the salesperson or the customer can rotate touch panels TP2 and TP1 of transaction equipment 100 such that the longitudinal direction of the housing of transaction equipment 100 is parallel to the vertical direction, the salesperson or the customer can easily see the operation screen of the application including characters or numerals displayed on touch panels TP2 and TP1, and can easily operate the operation screen.

As shown in FIG. 4C, in docking device 200, rotatable pedestal RTS1 can be rotated in the panning direction (arrow v3 direction) from the position in the state of FIG. 3 (that is, a state in which transaction equipment 100 is attached to docking device 200). Thus, since the salesperson can turn the operation screen of the application displayed on touch panel TP2 of transaction equipment 100 toward the salesperson or the customer, the salesperson and the customer facing the salesperson can simply perform the operation on touch panel TP2.

### Configuration of Transaction Equipment

Hereinafter, the hardware configuration of transaction equipment 100 of the present exemplary embodiment will be described with reference to FIG. 5. FIG. 5 is a diagram showing an example of the hardware configuration of transaction equipment 100 of the present exemplary embodiment. Transaction equipment 100 shown in FIG. 5 has non-secured area TA and secured area SA. “Secure” mentioned herein means that the area has tamper resistance. “Non-secure” means that the area has no tamper resistance. “Tamper resistance” refers to resistance to illegal analysis and modification of software or hardware within equipment, illegal piracy and modification, of information within the equipment, and attack to allow the information to be disabled. That is, the tamper resistance refers to the difficulty of analyzing stored data or the internal structure of the hardware or the software. The area has the tramper resistance, and thus, information of a service receiver (for example, the customer) can be protected and the transaction can be safely performed.

In secured area SA, tamper detection circuit 20 that detects whether or not a physical unauthorized behavior (for example, breakage and damage of transaction equipment 100) is performed, CPU 21 with internal memory, first I/F (interface) 22, first touch-input detector 23a, internal display 23b, power-supply 24, and battery 25 are provided. First touch-input detector 23a and internal display 23b constitute touch panel TP1. In CPU 21 with internal memory, first. CPU 21a, first flash ROM (Read Only Memory) 21b, and first RAM (Random Access Memory) 21c are provided.

In secured area SA, various components are electrically and logically connected to first CPU 21a. First CPU 21a manages all the components in secured area SA. For example, first CPU 21a performs various controls, processes, settings, determinations, checks, authentications, inquires (for example, an inquiry about PIN or signature), and instructions by executing programs stored in first flash ROM 21b.

First flash ROM 21b stores an encryption key used in communication with settlement server STLC (see FIG. 1, for example, the settlement relay center device or the settlement center device), personal information such as a PIN, confidential information such as settlement information regarding the settlement, or programs for transaction equipment 100 to receive a PIN input and an inquiry of the settlement. First flash ROM 21b is an example of a storage medium that stores programs and data for information processing in first CPU 21a.

For example, when processes associated with the reception of the PIN input and the inquiry of the settlement of transaction equipment 100 (for example, secured area SA) are performed, first RAM 21c is a work memory used to temporarily store processing data generated during the process.

Tamper detection circuit 20 constantly monitors secured area SA, and detects the physical unauthorized behavior (for example, the analysis, breakage or unsealing of secured area SA of transaction equipment 100) of secured area SA. In other words, tamper detection circuit 20 detects whether or not abnormality occurs in secured area SA. In a case where an event of the physical unauthorized behavior is detected by tamper detection circuit 20, CPU 21 with internal memory or second CPU 31 may forcibly stop the settlement process in the settlement application, or may notify that the physical unauthorized behavior is detected in secured area SA through at least one of touch panels TP1 and TP2.

First I/F 22 is provided to electrically connect non-secured area TA to secured area SA, and delivers various data items or commands between non-secured area TA and secured area SA through second I/F 36. First I/F 22 and second I/F 36 can be coupled to each other.

First touch-input detector 23a detects the touch input of the salesperson or the customer on touch panel TP1. For example, first touch-input detector 23a may detect an input on a PIN pad as a physical keypad or a software keyboard for inputting the PIN. For example, first touch-input detector 23a may detect a signature input using a finger or a stylus pen. For example, first touch-input detector 23a may detect a handwritten input of the PIN by using a finger or a stylus pen.

For example, internal display 23b is a LCD (Liquid Crystal Display) or an organic EL (Electroluminescence), and displays, for example, predetermined data (for example, numeric keys) for inputting the authentication information (for example, the PIN or signature) of the customer in the settlement application. Data displayed on internal display 23b is not limited to the numeric keys.

Power-supply 24 is a power supply of secured area SA, receives power from battery 25, and supplies power to secured area SA (for example, first CPU 21a). First CPU 21a can supply the power and stop the supply of the power to a part or all of the circuits arranged in secured area SA by controlling power-supply 24.

In non-secured area TA, second CPU 31, second flash ROM 32, second RAM 33, second touch-input detector 34a, internal display 34b as an example of a display unit, second I/F 36, power-supply 37, battery 38, out-camera 39, local area radio communicator 40 to which local area radio antenna 40a is connected, wide area radio communicator 41 to which wide area radio antenna 41a is connected, key-input unit 42, magnetic card reader 43a, contact IC card reader 43b, non-contact IC card reader/writer 43c to which loop antenna LA1 is connected, accelerometer 45, and docking device I/F 46 are provided. Second touch-input detector 34a and internal display 34b constitute touch panel TP2.

In non-secured area TA, various components are electrically and logically connected to second CPU 31. Second CPU 31 manages all the components in non-secured area TA. For example, second CPU 31 performs various controls, processes, settings, determinations and instructions by executing programs stored in second flash ROM 32. Second CPU 31 as an example of an application controller starts and executes various applications stored in second flash ROM 32, and pauses or ends the execution in response to the operation of the salesperson.

Second flash ROM 32 stores various data items and programs. The stored data and program are a program and data used in the settlement application and the business application (for example, a merchandise registration application, a stock management application, a document creation application used on a daily basis, and a spread sheet application), and may be a program for controlling transaction equipment 100 (for example, non-secured area TA). Accordingly, second flash ROM 32 is an example of a storage medium that stores programs and data for information processing in second CPU 31.

For example, when processes associated with the operations of transaction equipment 100 (for example, the components in non-secured area TA) are performed, second RAM 33 is a work memory used to temporarily store processing data generated during the process.

Second touch-input detector 34a detects the touch input of the salesperson or the customer on touch panel TP2. For example, second touch-input detector 34a detects the input on the operation screen of at least one of the settlement application and the business application (for example, the merchandise registration application) displayed on touch panel TP2.

Internal display 34b is, for example, a LCD (Liquid Crystal Display) or an organic EL (Electroluminescence), and displays data regarding the operation screen for inputting various information items (for example, a card brand, a card number, an expiration date, an amount of money, a payment method, and the number of payments) related to the settlement process using the card in, for example, the settlement application, or displays data regarding the operation screen for inputting the quantities or items of merchandises as a sales target in the merchandise registration application. The size of the display area of internal display 34b is less than the size of the display area of external display 500. In other words, even though the operation screens of the same application are considered, the operation screen displayed on external display 500 is larger than the operation screen displayed on internal display 34b, and thus, the salesperson or the customer can easily see the screens.

Second I/F 36 is provided to electrically connect non-secured area TA to secured area SA, and delivers various data items and commands between non-secured area TA and secured area SA through first I/F 22. First I/F 22 and second I/F 36 can be coupled to each other.

Power-supply 37 is a power supply of non-secured area TA, and receives power from battery 38, and supplies power to non-secured area TA (for example, second CPU 31). Second CPU 31 can supply the power and stop the supply of the power to a part or all of the circuits arranged in non-secured area TA by controlling power-supply 37.

Out-camera 39 is a camera provided such that a lens is exposed from the housing of transaction equipment 100, and obtains image data by capturing an image of light in a range in which the light is incident on the lens in response to the operation on key-input unit 42 or touch panel TP2, for example.

Local area radio communicator 40 is connected to local area radio antenna 40a, and performs communication using, for example, a wireless LAN by using local area radio communication path. Local area radio communicator 40 may perform communication (for example, communication using Bluetooth (registered trademark)) other than wireless LAN communication.

Wide area radio communicator 41 is connected to wide area radio antenna 41a, and performs communication using a wide area radio communication path (for example, a WAN (Wide Area Network)). The communication in the wide area radio communication path may be performed using, for example, a radio telephone network (a cellular network (W-CDMA (Wideband Code Division Multiple Access), CDMA (Code Division Multiple Access) 2000, or LTE (Long Term Evolution)).

For example, in a case where various buttons are provided on the housing of transaction equipment 100, key-input unit 42 receives push operations of various buttons. In a case where various buttons are not provided on the housing of transaction equipment 100, key-input unit 42 may be omitted from the configuration of transaction equipment 100.

Magnetic card reader 43a is provided on a side surface of the housing of transaction equipment 100 close to non-secured area TA in the transverse direction (see FIG. 3), is provided with a slit which is formed in the side surface and through which a swipe operation is performed in a state in which the salesperson holds the magnetic card, and reads a magnetic stripe of the magnetic card in response to the swipe operation. Information regarding the magnetic stripe read by magnetic card reader 43a is input to second CPU 31. Magnetic card reader 43a may be provided within secured area SA.

Contact IC card reader 43b is disposed within an insertion hole of the contact IC card which is formed in the side surface of the housing of transaction equipment 100 close to secured area SA in the transverse direction (see FIG. 3), and reads card information registered in a chip within the contact IC card through an electrode of the contact IC card (for example, an IC credit card) inserted into the insertion hole. The card information read by contact IC card reader 43b is input to second CPU 31. Contact IC card reader 43b may be provided within secured area SA.

Non-contact IC card reader 43c is connected to loop antenna LA1 disposed in a portion of the housing of transaction equipment 100 close to non-secured area TA (that is, a portion which is substantially parallel to touch panel TP2), performs radio communication with the card (for example, the IC credit card) in a non-contact manner using NFC (Near Field Communication), and reads or writes the card information registered in the card. The card information read by non-contact IC card reader/writer 43c is input to second CPU 31. Non-contact IC card reader/writer 43c may regularly authenticate with respect to non-contact reader/writer 71 of docking device 200 whether or not the transaction equipment is electrically connected to docking device 200 through communication between loop antenna LA1 of transaction equipment 100 and loop antenna LA2 of docking device 200. Non-contact IC card reader/writer 43c to which loop antenna LA1 is connected may be provided within secured area SA.

Accelerometer 45 detects accelerations in an X-axis direction, a Y-axis direction and a Z-axis direction (see three-axis direction shown in FIG. 3) of transaction equipment 100, and outputs the detection result to second CPU 31. Accelerometer 45 can detect a gravity direction (a vertically downward direction, that is, a −Z-axis direction) of transaction equipment 100.

Docking device I/F 46 as an example of an attachment and separation detector performs a regular inquiry (for example, a challenge response process to be described below) about the determination of whether or not transaction equipment 100 and docking device 200 are electrically connected with respect to device authentication controller 63 (to be described below) of docking device. 200 through a connector.

As described above, transaction equipment 100 includes secured area SA and non-secured area TA. A “secured” portion requiring “tamper resistance” in transaction equipment 100 during the execution of various applications is localized to secured area SA. Meanwhile, many information processing devices (for example, smartphones or tablet terminals) distributed as devices for consumers or a part thereof are used in non-secured area TA, as a general-purpose platform.

By using the general-purpose platform in non-secured area TA, development resources of the settlement application and the business application are easily reused or applied. The settlement application and the business application are flexibly operated without stress by being processed by second CPU 31 of non-secured area TA having, for example, high arithmetic processing ability. Since various settlement application or business applications in which settlement schemes are diversified can be easily used, these applications can be installed in transaction equipment 100 in a short period of time.

### Configuration of Docking Device

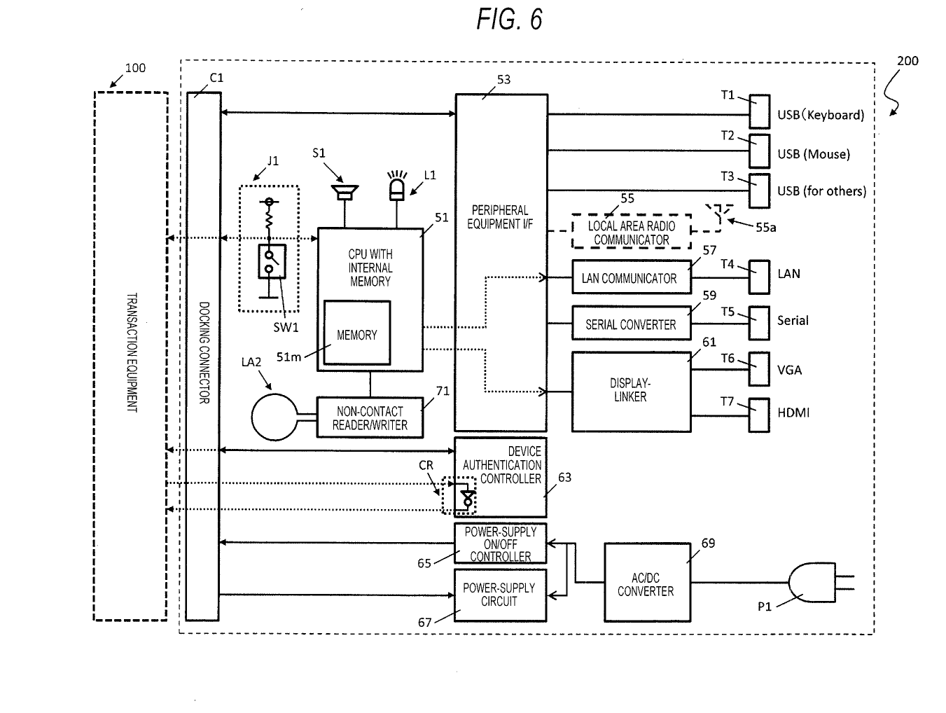

Hereinafter, the hardware configuration of docking device 200 of the present exemplary embodiment will be described with reference to FIG. 6. FIG. 6 is a diagram showing an example of the hardware configuration of docking device 200 of the present exemplary embodiment. In FIG. 6, transaction equipment 100 is also illustrated in order to conveniently describe the operation of docking device 200. Docking device 200 shown in FIG. 6 includes CPU 51 with internal memory, peripheral equipment I/F 53, local area radio communicator 55 to which local area radio antenna 55a is connected, LAN communicator 57, serial converter 59, display-linker 61, device authentication controller 63, power-supply on/off controller 65, power-supply circuit 67, AC/DC converter 69 to which power plug P1 is connected, non-contact reader/writer 71 to which loop antenna LA2 is connected, lock determination part J1, docking connector C1, speaker S1, and LED (Light Emitting Diode) lamp L1.

CPU 51 with internal memory includes memory 51m, and manages all the components in docking device 200. For example, CPU 51 with internal memory performs various controls, processes, settings, determinations, authentications, checks, inquiries and instructions by executing programs stored in memory 51m.

Memory 51m stores various programs and data required for the operation of docking device 200, and functions as a work memory which temporarily stores processing data generated during the operation of CPU 51 with internal memory.

Peripheral equipment I/F 53 delivers data with respect to various peripheral equipments (see FIG. 1) connected to various terminals (terminals T1, T2, T3, T4, T5, T6 and T7) in a direct manner or in an indirect manner through LAN communicator 57, serial converter 59 and display-linker 61. Terminals T1, T2 and T3 are directly connected to peripheral equipment I/F 53. Keyboard 700 is connected to terminal T1. Mouse 750 is connected to terminal T2. Other peripheral equipments (for example, PINPAD 600, sign pad 650, and barcode reader 800) are connected to terminal T3.

Local area radio communicator 55 is connected to local area radio antenna 55a, and performs communication using, for example, a wireless LAN by using a local area radio communication path. Local area radio communicator 55 may perform communication (for example, communication using Bluetooth (registered trademark)) other than wireless LAN communication. Local area radio communicator 55 to which local area radio antenna 55a is connected is omitted from docking device 200 in some cases. In this case, after transaction equipment 100 establishes a radio communication link with the peripheral equipment by a method to be described below, the transaction equipment can directly perform radio communication with the peripheral equipment (see FIG. 1) connected to docking device 200.

LAN communicator 57 is connected to terminal T4, is connected to a local network (for example, an intranet of the store) through terminal T4, and performs transmission and reception of data with this network. For example, the intranet of the store is connected to terminal T4.

Serial converter 59 is connected to terminal T5, performs serial-to-parallel conversion of data, and performs the transmission of print data of the predetermined receipts (for example, the customer receipt and the store receipt) transmitted from transaction equipment 100 or the reception of a print completion notification of the print data transmitted from receipt printer 300 with respect to receipt printer 300 connected to terminal T5. Serial converter 59 transmits a control signal for pushing cash drawer 400 in the opening direction to cash drawer 400 through receipt printer 300. Receipt printer 300 is connected to terminal T5.

Display-linker 61 is connected to terminals T6 and T7, and delivers data regarding at least one operation screen of the settlement application and the business application transmitted from transaction equipment 100 to external display 500 or customer display 550 connected to terminals T6 and T7. External display 500 or customer display 550 capable of handling data corresponding to VGA (Video Graphical Array) is connected to terminal T6. External display 500 or customer display 550 capable of handling data corresponding to HDMI (High-Definition Multimedia Interface) (registered trademark) is connected to terminal T7.

Device authentication controller 63 includes challenge response controller CR, and regularly performs a challenge response process as an authentication method for authenticating whether or not transaction equipment 100 and docking device 200 are correctly connected. In the challenge response process, challenge data is sequentially delivered to challenge response controller CR, docking connector C1, the connector of transaction equipment 100, docking device I/F 46, and second CPU 31, and response data is sequentially delivered to second CPU 31, docking device I/F 46, the connector of transaction equipment 100, docking connector C1, and challenge response controller CR. In a case where correct response data is obtained as the processing result of challenge response controller CR, device authentication controller 63 determines that correct transaction equipment 100 is attached to and is connected to docking device 200.

Power-supply on/off controller 65 receives a part of a DC power obtained by converting (for example, rectification and smoothing) a commercial power supply (power) supplied to power plug P1 in AC/DC converter 69 and determines whether or not to supply the DC power to transaction equipment 100 through docking connector C1. The commercial power supply is constantly supplied to docking device 200 through power plug P1. However, since only batteries 25 and 38 are provided in transaction equipment 100, in a case where it is determined that the remaining capacity of batteries 25 and 38 of transaction equipment 100 is less than a predetermined value, power-supply on/off controller 65 can supply the power to transaction equipment 100. In other words, if the transaction equipment 100 is attached to and is connected to docking device 200, transaction equipment 100 can charge batteries 25 and 38.

Power-supply circuit 67 supplies power supplies (powers) that are suitable for various components for operating the various components of docking device 200 by using a part of the DC power obtained by performing conversion (for example, rectification and smoothing) in AC/DC converter 69.

Non-contact reader/writer 71 is connected to loop antenna LA2, and regularly authenticates whether or not the docking device is electrically connected to transaction equipment 100 with respect to non-contact IC card reader/writer 43c of transaction equipment 100 through communication between loop antenna LA2 and loop antenna LA1 of transaction equipment 100.

Locking determination part J1 includes switch SW1, and determines whether or not transaction equipment 100 is physically attached to and is fixed to docking device 200. Specifically, in a case where the housing of transaction equipment 100 is held in and is attached to equipment holder ECP of docking device 200 and locking part J2 is fixed through a tool such as a driver, switch SW1 is turned on, and thus, locking determination part J1 determines that transaction equipment 100 is physically attached to and is fixed to docking device 200. Meanwhile, in a case where the housing of transaction equipment 100 is not held in equipment holding space ECPV of docking device 200, or in a case where the housing of the transaction equipment is held in and is attached to equipment holding space and locking part J2 is not fixed through the tool such as the driver, switch SW1 is turned off, and thus, locking determination part J1 determines that transaction equipment 100 is not physically fixed to docking device 200. Although it has been described that the ON and OFF of switch SW1 and the attachment and detachment of transaction equipment 100 to and from docking device 200 correspond to each other, and vice versa. In other words, in a case where switch SW1 is turned off, transaction equipment 100 may be physically fixed to docking device 200, and in a case where switch SW1 is turned on, transaction equipment 100 may not be physically fixed to docking device 200.

In a case where the housing of transaction equipment 100 is held in and is attached to equipment holder ECP of docking device 200, docking connector C1 electrically connects transaction equipment 100 and docking device 200.

In a case where a predetermined condition is satisfied, speaker S1 outputs an alert sound having a predetermined volume in response to an instruction of CPU 51 with internal memory.

LED lamp L1 can emit light of a LED, and emits light of predetermined color (for example, blue) in response to an instruction of CPU 51 with internal memory in a case where a predetermined condition is satisfied.

### Example of Operation Screen of Settlement Application

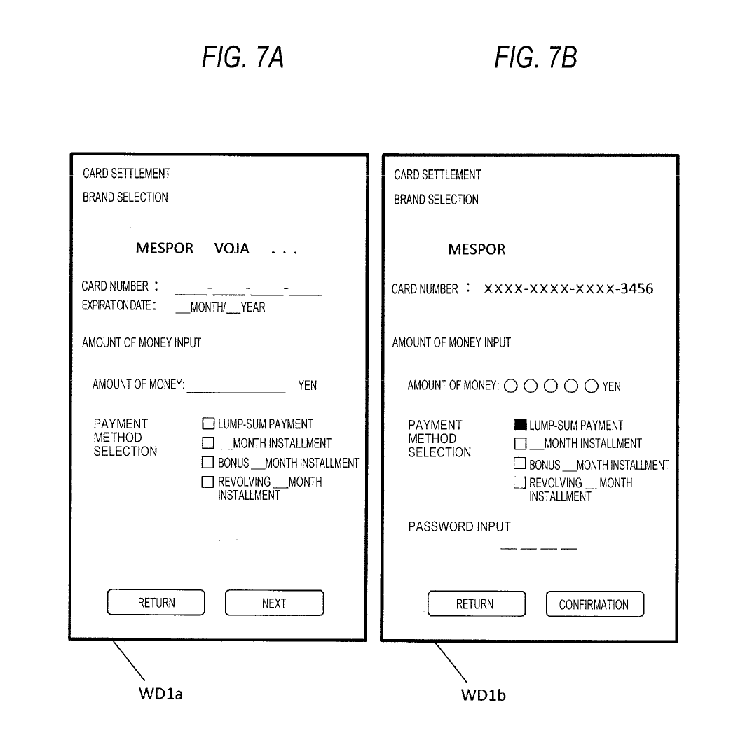

Hereinafter, the operation screen of the settlement application (for example, a card settlement application) installed in transaction equipment 100 will be described with reference to FIGS. 7A and 7B. FIG. 7A is a diagram showing a first example in which operation screen WD1a of the card settlement application executable in transaction equipment 100 is displayed on touch panel TP2 of transaction equipment 100. FIG. 7B is a diagram showing a second example in which operation screen WD1b of the card settlement application executable in transaction equipment 100 is displayed on touch panel TP2 of transaction equipment 100.

On operation screen WD1a shown in FIG. 7A, a card brand of a card used in the settlement of the commercial transaction is displayed such that the salesperson can select the card brand from “MESPOR”, “VOJA”, . . . , and a card number, an expiration date of the card, a settlement amount of money of the commercial transaction, a payment method as a settlement method of the card, and the number of payments are displayed. If the number of payments is input, an item “next” is input through the touch, and an input screen of settlement information (for example, a PIN as authentication information) which is subsequently input is displayed.

On operation screen WD1b shown in FIG. 7B, an input area for inputting the authentication information (for example, the PIN) for authenticating the customer as a legitimate owner of the card in addition to screen operation WD1a shown in FIG. 7A. On the operation screen shown in FIG. 7B, a card brand “MESPOR” is already selected, a card number “xxxx-xxxx-xxxx-3456” and an expiration data thereof (is not displayed after the card number and the expiration data are input) are input, and the payment amount of money and “lum-sum payment” as the payment method are input.

For example, in a case where the PIN is input as the authentication information for authenticating the customer as the legitimate owner of the card, transaction equipment 100 transmits the authorization inquiry of the settlement process including the card brand, the card number, the expiration data, the amount of money, the payment method, the number of payments, and the PIN to settlement server STLC through in a direct manner or in an indirect manner through docking device 200, in response to the input operation of the salesperson. In settlement server STLC, the determination (that is, the determination of whether or not to authorize the customer as a target of the settlement process) of the authorization inquiry is performed, and the determination result (for example, notification that the authorization is possible) of the authorization inquiry is transmitted to transaction equipment 100 from settlement server STLC in the direct manner or in the indirect manner through docking device 200. If the determination result (for example, notification that the authorization is possible) of the authorization inquiry is received, transaction equipment 100 transmits a process request for sales registration of the amount of money in the settlement process of the commercial transaction to settlement server STLC in the direct manner or the indirect manner through docking device 200. In settlement server STLC, a sales registration process is performed in response to the process request for the sales registration from transaction equipment 100, and the processing result of the sales registration is sent to transaction equipment 100. Thus, transaction equipment 100 can determine that the settlement process related to one commercial transaction is normally ended in the settlement application.

### Example of Operation Screen of Merchandise Registration Application

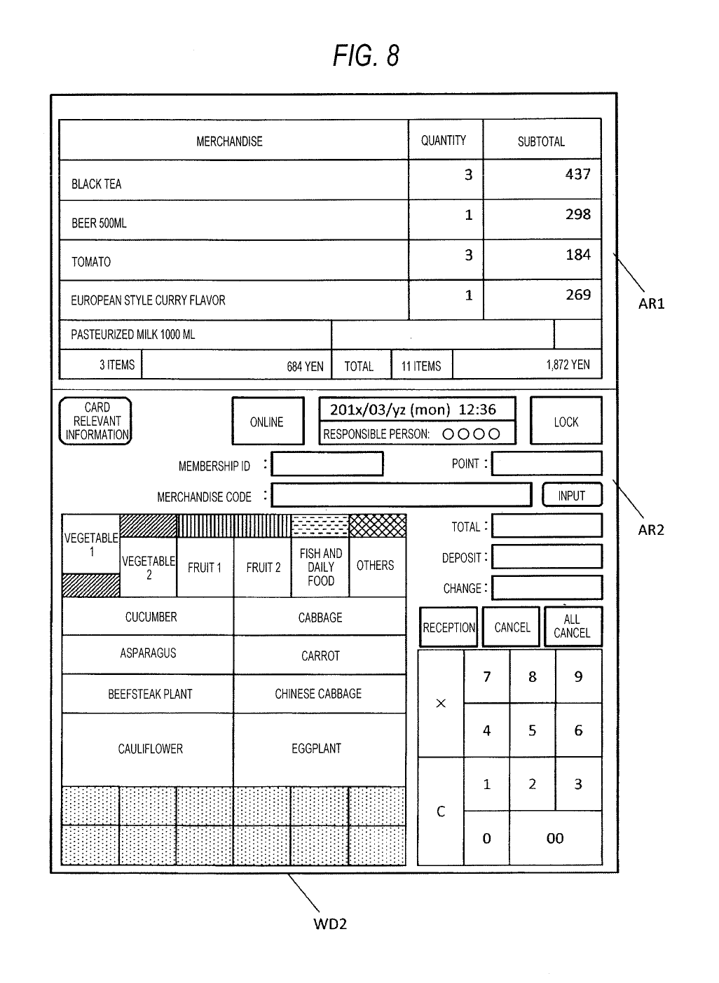

Hereinafter, operation screen WD2 of the merchandise registration application (that is, an application for registering the quantities or items of the services or merchandises as sales targets in a database inside or outside the store) installed in transaction equipment 100 will be described with reference to FIG. 8. FIG. 8 is a diagram showing an example in which operation screen WD2 of the merchandise registration application executable in transaction equipment 100 is displayed on touch panel TP2 of transaction equipment 100.

Operation screen WD2 shown in FIG. 8 includes an item and quantity display area AR2 for inputting the items and quantities of the merchandises or services as sales targets, and a registering target list display area AR1 for displaying the item, quantity and subtotal (that is, the product of the unit price and quantity of merchandises or services) of the merchandises or services input in item and quantity display area AR2 and the total amount of money (that is, the payment amount of money of the customer) related to the settlement (for example, a cash settlement or a card settlement) of the commercial transaction.

Transaction equipment 100 displays operation screen WD2 on internal display 34b shown in FIG. 8 after the merchandise registration application is started. For example, in a case where the customer purchases “three black tea products”, “one can of 500-ml beer”, “three tomatoes”, “one European style curry flavor” and “three cartons of 1000-ml pasteurized milk”, the salesperson sequentially inputs combinations of the items and quantities of the merchandises as sales targets on item and quantity display area AR2 of operation screen WD2 displayed on internal display 34b through the touch. For example, the salesperson may input the items and quantities of all the merchandises by reading barcodes assigned to the merchandises by means of barcode reader 800 even though the salesperson does not perform the touch input. If the input of the items and quantities of all the merchandises is ended, transaction equipment 100 displays the merchandises as sales targets, the quantities of the merchandises, and the payment amount of money on registering target list display area AR1 of operation screen WD2 displayed on internal display 34b. Thus, during the execution of the merchandise registration application, transaction equipment 100 can register the services or merchandises as sales targets, and the quantities and the total amount of money thereof in correlation with a sales date and identification information (for example, the name of the salesperson) regarding the salesperson in response to the operation on operation screen WD2 shown in FIG. 8.

### Operation Related to Communication Link Establishment Between Transaction Equipment and Peripheral Equipment

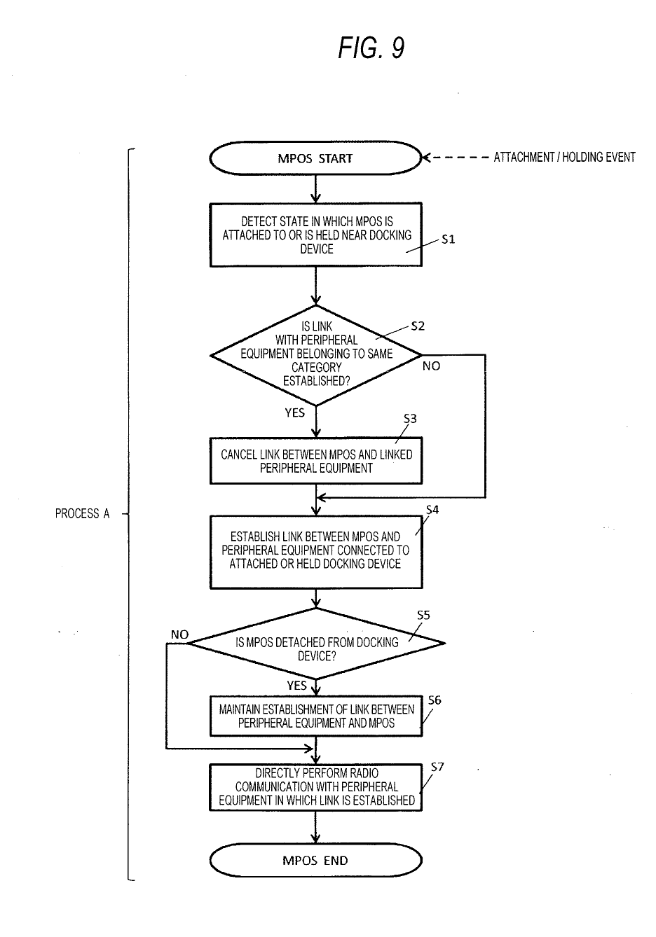

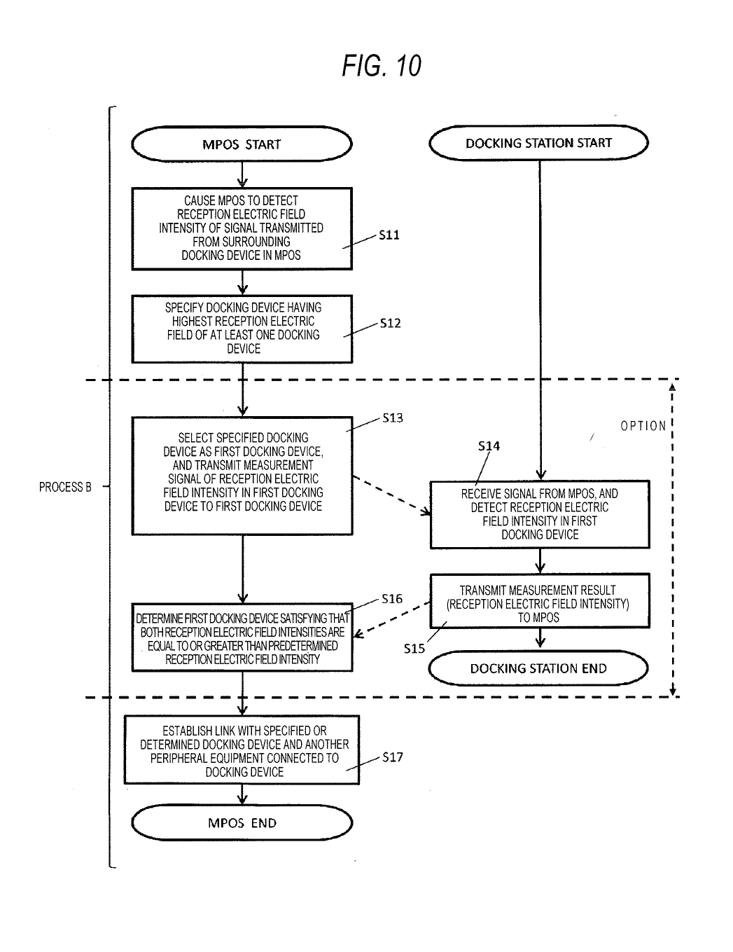

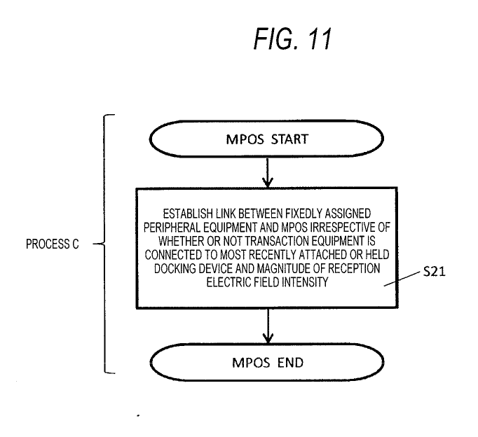

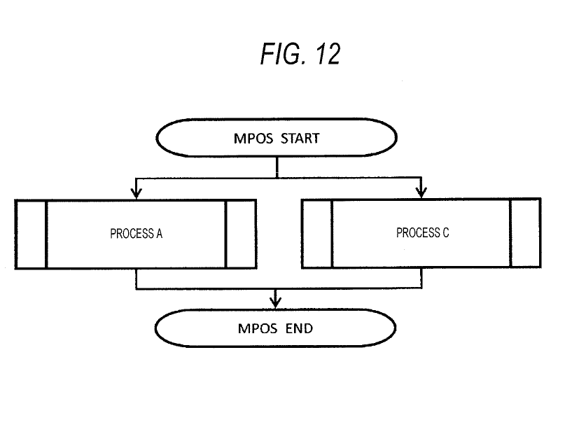

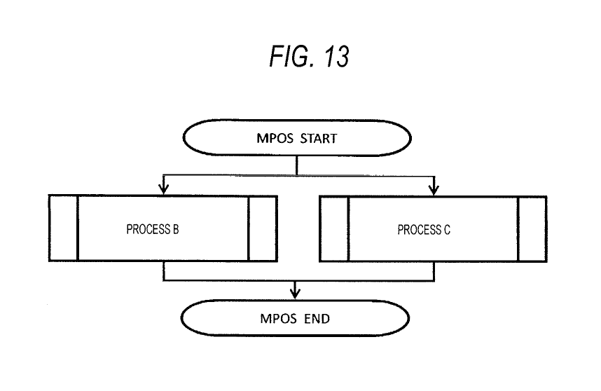

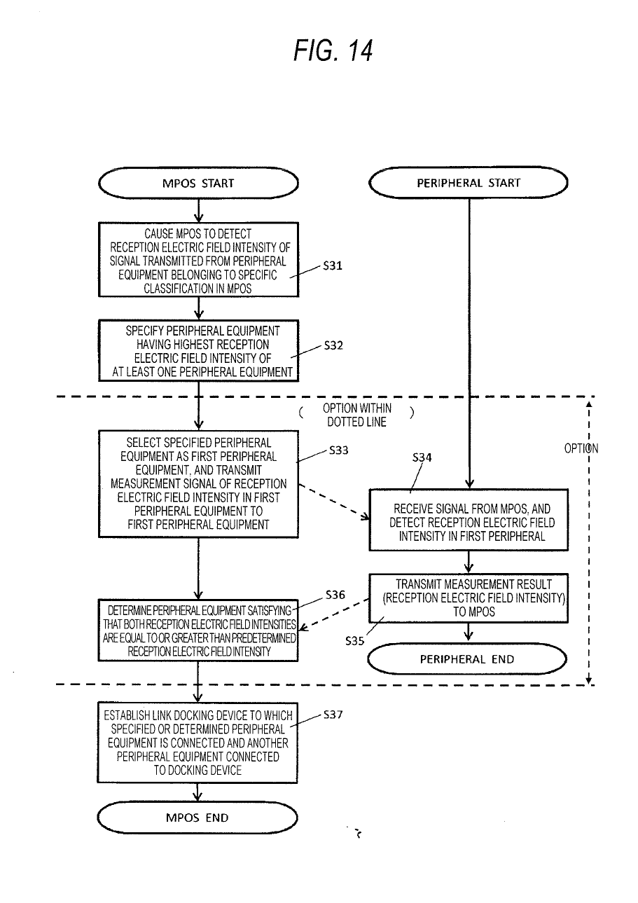

Hereinafter, the operation related to radio communication link establishment between transaction equipment 100 and peripheral equipment will be described with reference to FIGS. 9 to 14. FIG. 9 is a flowchart for describing an example of an operation procedure related to communication link establishment with the peripheral equipment when transaction equipment 100 of the present exemplary embodiment is attached to or is held near docking device 200. FIG. 10 is a flowchart for describing an example of an operation procedure related to communication link establishment depending on reception electric field intensity when a signal is received between docking device 200 and transaction equipment 100 of the present exemplary embodiment. FIG. 11 is a flowchart for describing an example of an operation procedure in which transaction equipment 100 of the present exemplary embodiment establishes communication link with fixedly assigned peripheral equipment (for example, common printer Ptr0). FIG. 12 is a flowchart for describing an example of an operation procedure when the operation procedure shown in FIG. 9 and the operation procedure shown in FIG. 11 are performed in parallel. FIG. 13 is a flowchart for describing an example of an operation procedure when the operation procedure shown in FIG. 10 and the operation procedure shown in FIG. 11 are performed in parallel. FIG. 14 is a flowchart for describing an example of an operation procedure related to the communication link establishment depending on the reception electric field intensity when the signal is received between transaction equipment 100 of the present exemplary embodiment and the peripheral equipment.

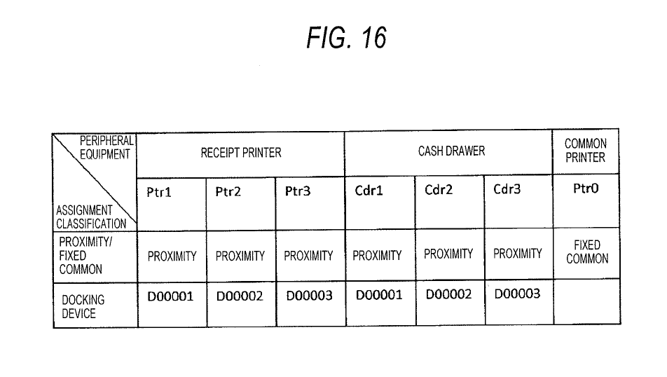

FIG. 16 is a table showing an example of the relationship between the common printer and the docking device and the peripheral equipment constituting the docking group. As shown in FIG. 16, radio communication links with the receipt printers having identifiers of “Ptr1”, “Ptr2” and “Ptr3” and the cash drawers having identifiers of “Cdr1”, “Cdr2” and “Cdr3” are established based on geographical proximity of transaction equipment 100.

A common printer having an identifier of “Ptr3” is a kind of receipt printer, and a radio communication link with this common printer is established so as to be shared by a plurality of transaction equipments irrespective of the geographical proximity of transaction equipment 100 (that is, peripheral equipment connected to the most recently attached docking device in the proximity of transaction equipment 100, peripheral equipment connected to the docking device of which the reception electric field intensity of the signal from transaction equipment 100 is equal to or greater than a predetermined value, or peripheral equipment of which the reception electric field intensity of the signal from transaction equipment 100 is equal to or greater than a predetermined value).

A receipt printer having an identifier of “Ptr1” and a cash drawer having an identifier of “Cdr1” are connected to a docking device having an identifier of “D00001”. A receipt printer having an identifier of “Ptr2” and a cash drawer having an identifier of “Cdr2” are connected to a docking device having an identifier of “D00002”. A receipt printer having an identifier of “Ptr3” and a cash drawer having an identifier of “Cdr3” are connected to a docking device having an identifier of “D00003”.

In FIG. 9, if transaction equipment 100 is attached to or is held near a predetermined docking device (for example, docking device 200 to or near which transaction equipment 100 is most recently attached or held), second CPU 31 of transaction equipment 100 detects a state in which the transaction equipment is attached to docking device 200 or a state in which the transaction equipment is held near docking device 200 (S1). For example, second CPU 31 detects the state in which the transaction equipment is attached to docking device 200 based on the processing result of the challenge response process with respect to device authentication controller 63 of docking device 200 through docking device I/F 46. Second CPU 31 detects the state in which the transaction equipment is held near docking device 200 based on the communication with non-contact reader/writer 71 and loop antenna LA2 of docking device 200 through non-contact IC card reader/writer 43c and loop antenna LA1.

At a time when transaction equipment 100 is attached to docking device 200 or at a time when the transaction equipment is held near the docking device, in a case where the radio communication link is still established between transaction equipment 100 and the peripheral equipment (for example, the receipt printer) of which the category is the same as that of the peripheral equipment connected to the most recently attached or held docking device 200 (S2, YES), second CPU 31 cancels the radio communication link establishment between the peripheral equipment and transaction equipment 100 (S3). Meanwhile, in a case where the radio communication link establishment is already cancelled (S2, NO), the process of transaction equipment 100 proceeds to step S4.

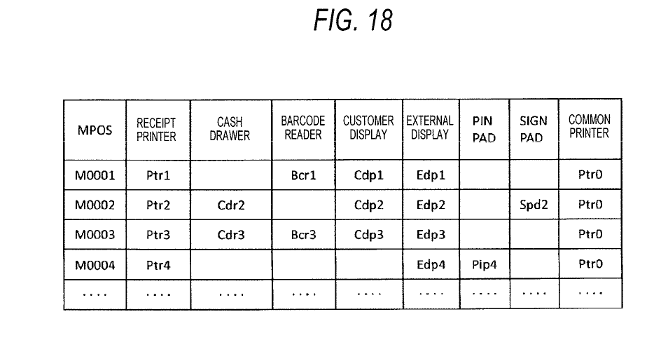

Second CPU 31 as an example of a link establisher establishes the radio communication link (S4, see FIG. 18) between transaction equipment 100 and at least one peripheral equipment (for example, receipt printer 300) connected to the attached or held docking device (for example, docking device 200). FIG. 18 is a table showing an example of at least one peripheral equipment in which the communication link with transaction equipment 100 is established.

For example as shown in FIG. 18, in a case where the identifier of transaction equipment 100 is “M0001”, transaction equipment 100 having an identifier of “M0001” can directly perform the radio communication with a receipt printer having an identifier of “Ptr1”, a barcode reader having an identifier of “Bcr1”, a customer display having an identifier of “Cdp1” and an external display having an identifier of “Edp1” through the process of step S4. Common printer Ptr3 will be described below.

After step S4, even in a case where transaction equipment 100 is detached from docking device 200 (S5, YES), second CPU 31 maintains the radio communication link established in step S4 (S6). Meanwhile, in a case where transaction equipment 100 is not detached from docking device 200 (S5, NO), the process of transaction equipment 100 proceeds to step S7.

If the radio communication link with at least one peripheral equipment is established in step S4, transaction equipment 100 directly performs the radio communication with at least one peripheral equipment in any state of a state in which the transaction equipment 100 is detached from docking device 200 and is held by the salesperson or a state in which the transaction equipment is attached to docking device 200 (S7).

Accordingly, in a case where transaction equipment 100 is attached to a predetermined docking device (for example, most recently attached docking device 200) which is geographically disposed in the proximity of transaction equipment 100, the radio communication link is established between transaction equipment 100 and the peripheral equipment connected to the docking device. Therefore, even through transaction equipment 100 is independently used be being detached from docking device 200, transaction equipment 100 can directly perform the radio communication with the peripheral equipment connected to docking device 200, and thus, it is possible to improve convenience when the salesperson uses the peripheral equipment.

In FIG. 10, a case where a plurality of docking devices is arranged near, for example, transaction equipment 100 used by the salesperson and the radio communication link is set between transaction equipment 100 and at least one peripheral equipment connected to docking device which is geographically present in the proximity of the salesperson is illustrated. As the assumption of the description shown in FIG. 10, local area radio communicators 55 to which local area radio antennas 55a is connected are provided at the plurality of docking devices.

In FIG. 10, local area radio communicator 40 receives signals (for example, measurement signals for reception electric field intensity) which are respectively transmitted from local area radio communicators 55 of the surrounding docking devices, and second CPU 31 of transaction equipment 100 detects and measures the reception qualities (for example, the reception electric field intensities, the same applies later) of the respective reception signals in transaction equipment 100 (S11).

Second CPU 31 specifies the docking device having the highest intensity among the reception electric field intensities of the respective reception signals measured in step S11 (S12).

Second CPU 31 selects the docking device specified in step S12 as a first docking device, and transmits a signal (that is, a measurement signal of reception electric field intensity in the first docking device) to local area radio communicator 40 of the first docking device (S13).

The first docking device (for example, docking device 200) receives the signal (that is, the measurement signal of reception electric field intensity in the first docking device) transmitted from transaction equipment 100 through local area radio communicator 55, and detects and measures the reception electric field intensity in the first docking device (S14). The first docking device transmits the measurement result (that is, the reception electric field intensity) in step S14 to transaction equipment 100 through local area radio communicator 55 (S15).

Transaction equipment 100 receives the measurement result transmitted from the first docking device through local area radio communicator 40. In a case where the reception electrical field intensities of the respective signals measured in steps S11 and S14 are equal to or greater than a predetermined reception electric field intensity, second CPU 31 determines the docking device satisfying that both the measurement results in steps S11 and S14 are equal to or greater than the predetermined reception electric field intensity as the first docking device (S16).

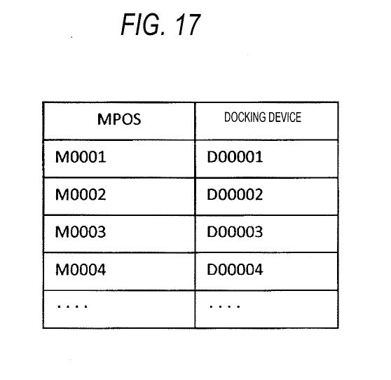

Second CPU 31 establishes the radio communication links with the first docking device (for example, docking device 200) determined in step S16 and another peripheral equipment connected to this docking device (S17). The processes of transaction equipment 100 and the first docking device (for example, docking device 200) from step S13 to step S16 shown in FIG. 10 may be omitted. In this case, second CPU 31 establishes the radio communication links with the first docking device (for example, docking device 200) specified in step S12 and another peripheral equipment connected to this docking device (S17, see FIGS. 17 and 18). FIG. 17 is a table showing an example of the docking device in which the communication link with the transaction equipment is established.

For example, as shown in FIG. 17, in a case where the identifier of transaction equipment 100 is “M0001”, transaction equipment 100 having an identifier of “M0001” can perform the radio communication with a docking device having an identifier of “D00001” through the process of step S17. Through the process of step S17, transaction equipment 100 having an identifier of “M0002” can perform the radio communication with a docking device having an identifier of “D00002”. Through the process of step S17, transaction equipment 100 having an identifier of “M0003” can perform the radio communication with a docking device having an identifier of “D00003”. Through the process of step S17, transaction equipment 100 having an identifier of “M0004” can perform radio communication with a docking device having an identifier of “D00004”.

For example, as shown in FIG. 18, in a case where the identifier of transaction equipment 100 is “M0002”, transaction equipment 100 having an identifier of “M0002” can directly perform radio communication with a receipt printer having an identifier of “Ptr2”, a cash drawer having an identifier of “Cdr2”, a customer display having an identifier of “Cdp2”, an external display having an identifier of “Edp2” and a sign pad having an identifier of “Spd2” through the process of step S17.

For example, as shown in FIG. 18, in a case where the identifier of transaction equipment 100 is “M0003”, transaction equipment 100 having an identifier of “M0003” can directly perform radio communication with a receipt printer having an identifier of “Ptr3”, a cash drawer having an identifier of “Cdr3”, a barcode reader having an identifier of “Bcr3”, a customer display having an identifier of “Cdp3” and an external display having an identifier of “Edp3” through the process of step S17.

Thus, transaction equipment 100 can establish radio communication links with peripheral equipment connected to a docking device (for example, a docking device having the highest reception electric field intensity in transaction equipment 100 or a docking device of which the reception electric field intensity of the received signal is equal to or greater than a predetermined value) which is geographically disposed in the proximity of transaction equipment 100. Accordingly, transaction equipment 100 can directly perform radio communication with the peripheral equipment connected to the first docking device which is geographically disposed in the proximity of transaction equipment 100, and thus, it is possible to improve convenience when the salesperson uses the peripheral equipment.

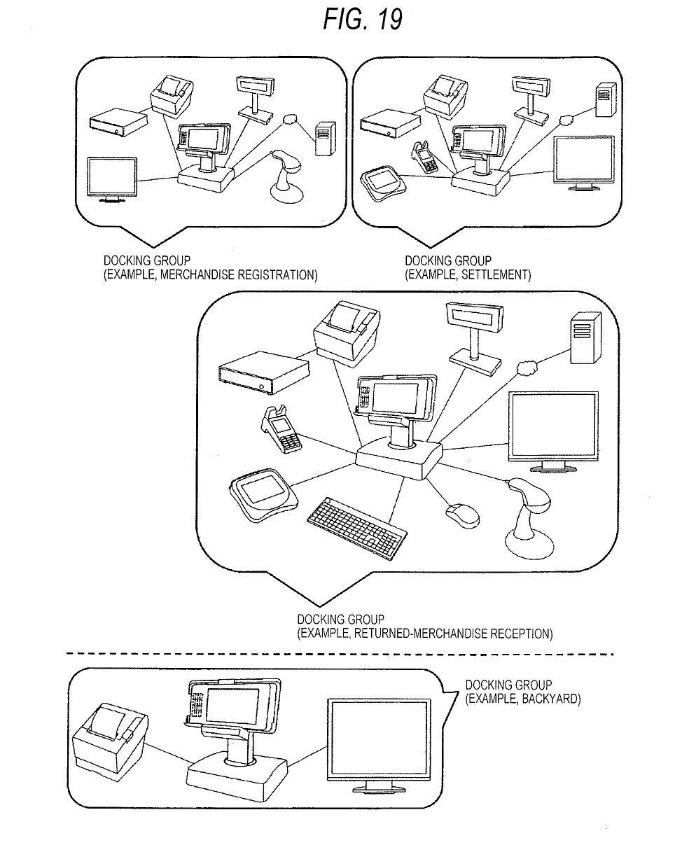

In FIG. 11, for example, the transaction equipment may be in any one state of a state in which the salesperson holds transaction equipment 100 as independent equipment, a state in which the transaction equipment is attached to the docking device, and a state in which the transaction equipment is held near the docking device. In all these states, second CPU 31 of transaction equipment 100 establishes a radio communication link with a common printer having an identifier of “Ptr3” shown in FIG. 16 (S21). The common printer is peripheral equipment that can be fixedly assigned irrespective of whether or not transaction equipment 100 used by the salesperson is connected to the most recently attached or the most recently held docking device or the magnitude of the reception electric field intensity of the signal transmitted to and received from the docking device. Accordingly, for example, transaction equipment 100 can perform radio communication with the common printer disposed so as to be separated from transaction equipment 100 through, for example, local area radio communicator 40 (see FIG. 18). As shown in FIG. 18, radio communication links are established between a common printer having an identifier of “Ptr0” and transaction equipments having identifiers of “M0001”, “M0002”, “M0003” and “M0004”. For example, as shown in FIG. 19, the common printer is an output printer for merchandise management disposed in the backyard within the store or an output printer for order reception disposed in the proximity of a kitchen within a restaurant. FIG. 19 is a schematic diagram showing an example of the layout of the docking group and the common printer arranged within the store.

In FIG. 19, the docking group including the docking device and at least one peripheral equipment connected to the docking device is disposed for each business (for example, merchandise registration, settlement, or returned-merchandise reception) within the store. The peripheral equipment including the receipt printer to which the cash drawer is connected, the external display, the customer display and the barcode reader is connected to the docking device of docking group Grp001 used in the merchandise registration business, and is connected to a merchandise registration management server through the network. The execution history of the merchandise registration is managed in the merchandise registration management server.

The peripheral equipment including the receipt printer to which the cash drawer is connected, the external display, the customer display, the PINPAD and the sign pad is connected to the docking device of docking group Grp002 used in the settlement business, and is connected to the settlement server (see FIG. 1) through the network.

The peripheral equipment including the receipt printer to which the cash drawer is connected, the external display, the customer display, the barcode reader, the mouse, the keyboard, the PINPAD and the sign pad is connected to the docking device of docking group Grp003 used in the returned-merchandise business, and is connected to the merchandise registration management server or the settlement server, or both the servers through the network.

The peripheral equipment including the common printer and the external display is connected to the docking device of docking group Grp004 provided in the backyard.

Hereinafter, in order to appropriately describe the flowcharts shown in FIGS. 12 and 13, the process of transaction equipment 100 of the flowchart shown in FIG. 9 is described as “Process A”, the process of transaction equipment 100 of the flowchart shown in FIG. 10 is described as “Process B”, and the process of transaction equipment 100 of the flowchart shown in FIG. 11 is described as “Process C”.

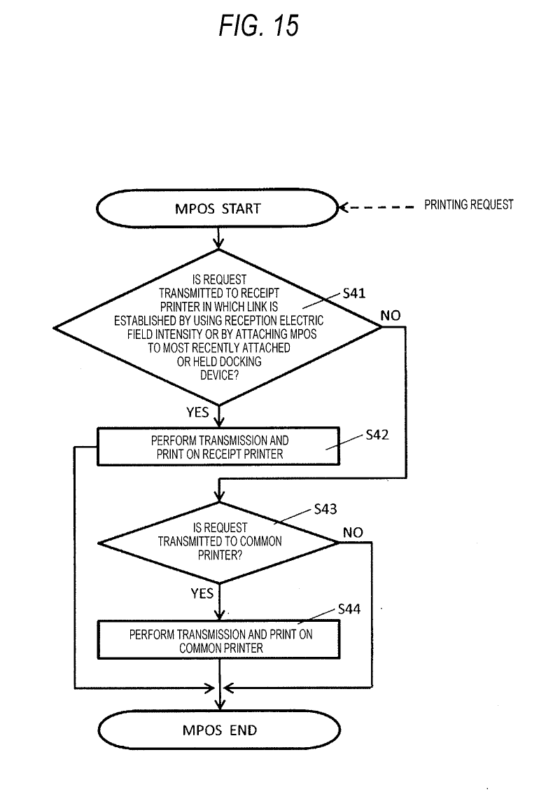

In FIG. 12, transaction equipment 100 performs Process C in parallel while performing Process A. In other words, in a case where the transaction equipment is connected to or is held near the most recently attached docking device, transaction equipment 100 establishes a radio communication link with a common printer (see FIG. 11) having an identifier of “Ptr0” while establishing a radio communication link with at least one peripheral equipment connected to the docking device. Accordingly, transaction equipment 100 can directly perform radio communication with the peripheral equipment which is geographically disposed in the proximity of the salesperson in response to the operation of the salesperson, and can request the common printer to perform a printing process through radio communication (see FIG. 15 to be described below).

In FIG. 13, transaction equipment 100 performs Process C in parallel while performing Process B. In other words, transaction equipment 100 establishes a radio communication link with at least one peripheral equipment connected to the first docking device having the heist intensity among the reception electric field intensities of the signals, which are transmitted from the plurality of surrounding docking devices, in transaction equipment 100, and establishes a radio communication link with the common printer (see FIG. 11) having an identifier of “Ptr0”. Accordingly, transaction equipment 100 can directly perform radio communication with the peripheral equipment which is geographically disposed in the proximity of the salesperson in response to the operation of the salesperson, and can request the common printer to perform the printing process through the radio communication (see FIG. 15 to be described below).

In FIG. 14, for example, a case where the plurality of docking groups is arranged near transaction equipment 100 used by the salesperson and transaction equipment 100 establishes radio communication links with the docking device connected to peripheral equipment belonging to the specific classification (for example, the receipt printer, the same applies later, and the peripheral equipment is not limited to the receipt printer) which is geographically present in the proximity of the salesperson and another peripheral equipment connected to the docking device is illustrated.

In FIG. 14, local area radio communicator 40 receives the signals (for example, the measurement signals for reception electric field intensity) transmitted from the receipt printers which are peripheral equipments belonging to the specific classification among the surrounding docking groups, and second CPU 31 of transaction equipment 100 detects and measures the reception qualities (for example, the reception electric field intensity, the same applies later) of the respective reception signals in transaction equipment 100 (S31).

Second CPU 31 specifies the peripheral equipment (that is, the receipt printer) having the highest intensity among the reception electric field intensities of the respective reception signals measured in step S31 (S32).

Second CPU 31 selects the peripheral equipment (that is, the receipt printer) specified in step S32 as the first peripheral equipment, and transmits the signal (that is, the measurement signal of reception electric field intensity in the first peripheral equipment) to local area radio communicator 40 of the first peripheral equipment (S33).

The first peripheral equipment (for example, receipt printer 300) receives the signal (that is, the measurement signal of reception electric field intensity in the first peripheral equipment) transmitted from transaction equipment 100, and detects and measures the reception electric field intensity in the first peripheral equipment (S34). The first peripheral equipment transmits the measurement result (that is, the reception electric field intensity) in step S34 to transaction equipment 100 (S35).

Transaction equipment 100 receives, the measurement result transmitted from the first peripheral equipment through local area radio communicator 40. In a case where the reception electric field intensities of the signals measured in steps S31 and S34 are equal to or greater than the predetermined reception electric field intensity, second CPU 31 determines the peripheral equipment satisfying that both the measurement results in steps S31 and S34 are equal to or greater than the predetermined reception electric field intensity, as the first peripheral equipment (S36).

Second CPU 31 establishes radio communication links with the first peripheral equipment (for example, receipt printer 300) determined in step S16, the docking device to which this peripheral equipment is connected and another peripheral equipment connected to this docking device (S37). The processes of transaction equipment 100 and the first peripheral equipment (for example, receipt printer 300) from step S33 to step S36 shown in FIG. 14 may be omitted. In this case, second CPU 31 establishes radio communication links with the first peripheral equipment (for example, receipt printer 300) specified in step S32, the docking device to which the peripheral equipment is connected and another peripheral equipment connected to this docking device (see S37, and FIGS. 17 and 18).

For example, as shown in FIG. 18, in a case where the identifier of transaction equipment 100 is “M0004”, transaction equipment 100 having an identifier of “M0004” can directly perform radio communication with a receipt printer having an identifier of “Ptr4”, an external display having an identifier of “Edp4”, and a PINPAD having an identifier of “Pip4” through the process of step S37.

Accordingly, transaction equipment 100 can establish a radio communication link with the docking device connected to the peripheral equipment belonging to the specific classification (for example, the peripheral equipment having the highest reception electric field intensity in transaction equipment 100 or the peripheral equipment of which the reception electric field intensity of the signal which is mutually transmitted and received is equal to or greater than the predetermined intensity) which is geographically disposed in the proximity of transaction equipment 100 and another peripheral equipment connected to this docking device. Accordingly, transaction equipment 100 can directly perform radio communication with the first peripheral equipment which is geographically disposed in the proximity of transaction equipment 100, or the docking device to which the first peripheral equipment is connected and another peripheral equipment connected to this docking device, and thus, it is possible to improve convenience when the salesperson uses the peripheral equipment. Especially in a case where local area radio communicator 55 for performing radio communication with transaction equipment 100 is not provided in the docking device, transaction equipment 100 can directly perform the radio communication with the first peripheral equipment which is geographically disposed in the proximity of transaction equipment 100 or another peripheral equipment connected to the docking device connected to the first peripheral equipment, and thus, it is possible to similarly improve convenience when the salesperson uses the peripheral equipment even in a case where local area radio communicator 55 is not provided in the docking device.

Hereinafter, an operation procedure when transaction equipment 100 of the present exemplary embodiment requests the common printer to print data on an operation screen of at least one procedure of the settlement application and the business application will be described with reference to FIG. 15. FIG. 15 is a flowchart for describing an example of an operation procedure of the transaction equipment of the present exemplary embodiment in a case where the receipt printer as an example of the peripheral equipment is requested to print.

In FIG. 15, if the transaction equipment requests the printer to print the data on the operation screen of at least one procedure of the settlement application and the business application through the operation of the salesperson, second CPU 31 of transaction equipment 100 obtains information regarding a printing destination device (for example, the identifier of the receipt printer) included in the print request. Second CPU 31 determines whether or not the printing destination device is the receipt printer in which the communication link is established by using the reception electric field intensity (see FIG. 10 or 14) or by being attached to or held near the most recently attached to or held docking device (see FIG. 9) (S41). In a case where it is determined that the printing destination device is not the receipt printer in which the communication link is established by using the reception electric field intensity or by being attached to or held near the most recently attached to or held docking device (S41, NO), the process of transaction equipment 100 proceeds to step S43.

Meanwhile, in a case where it is determined that the printing destination device is the receipt printer in which the communication link is established by using the reception electric field intensity or by being attached to or held near the most recently attached to or held docking device (S41, YES), second CPU 31 transmits the print data to the receipt printer which is the corresponding printing destination device through local area radio communicator 40 (S42). Accordingly, the receipt printer (for example, receipt printer 300) can perform the printing process by using the print data transmitted from transaction equipment 100 (S42).

In a case where it is determined that the printing destination device is the common printer (for example, the common printer having an identifier of “Ptr0”) (S43, YES), second CPU 31 transmits the print data to the common printer through local area radio communicator 40 (S44). Accordingly, the common printer (for example, the common printer having an identifier of “Ptr0”) can perform the printing process by using the print data transmitted from transaction equipment 100 (S44).

As described above, in transaction processing system 1000 of the present exemplary embodiment, transaction equipment 100 receives the signals transmitted from the plurality of docking devices (for example, the plurality of docking devices including docking device 200) connected to at least one peripheral equipment (for example, receipt printer 300) used in the settlement application or the business application. Transaction equipment 100 selects any one (for example, the docking device having the highest reception electric field intensity) of the docking devices as the first docking device based on the reception qualities (for example, the reception electric field intensities) of the respective signals transmitted from the plurality of docking devices. Transaction equipment 100 establishes the radio communication link with at least one peripheral equipment connected to the first docking device.

Accordingly, when the transaction equipment 100 is operated in cooperation with the peripheral equipment (for example, receipt printer 300) used in at least one target procedure of the merchandise registration application and the settlement application, since transaction equipment 100 can easily cooperate with the peripheral equipment to be used, which is connected to the docking device geographically disposed in the proximity of transaction equipment 100 while the salesperson holds transaction equipment 100 without the attachment of the transaction equipment to the docking device (for example, docking device 200) without requiring the complicated setting operation, it is possible to prevent degradation in customer service quality. Accordingly, transaction equipment 100 can prevent a decline in purchaser's eagerness to purchase or degradation in loss of sales opportunity of the store, and thus, it is possible to prevent a decrease in sales. Particularly, in the store that handles the card settlement, transaction equipment 100 can prevent a decrease in fee income of a service provider such as an acquirer related to the card settlement.

According to the program for causing transaction equipment 100 to perform a predetermined procedure, it is also possible to perform the same process as that of transaction equipment 100 not in transaction equipment 100 but in the external device by causing the external device (for example, a tablet terminal) to perform the procedure defined in the program. The predetermined procedure mentioned herein includes a process of receiving signals transmitted from the plurality of docking devices connected to at least one peripheral equipment used in the settlement application or the business application, a process of selecting any one of the docking devices as the first docking device based on the reception qualities of the respective signals transmitted from the plurality of docking devices, and a process of establishing the radio communication link with at least one peripheral equipment connected to the selected first docking device.

Transaction equipment 100 transmits a signal for reception quality detection to the first docking device (for example, docking device 200), and establishes the radio communication link with at least one peripheral equipment connected to the first docking device in a case where the reception quality (for example, reception electric field intensity) of the signal for reception quality detection in the first docking device is equal to or greater than a predetermined value. Accordingly, in both cases of a case where the salesperson holds transaction equipment 100 and a case where the salesperson attaches transaction equipment 100 to the first docking device (for example, docking device 200), transaction equipment 100 can easily perform radio communication with at least one peripheral equipment connected to the first docking device geographically disposed in the proximity of transaction equipment 100.

Transaction equipment 100 receives the signals transmitted from the peripheral equipments (for example, receipt printers 300) belonging to the specific classification which are used in the settlement application or the business application and are connected to each of the plurality of docking devices. Transaction equipment 100 selects any one (for example, the peripheral equipment belonging to the specific classification having the highest reception electric field intensity) of the peripheral equipments belonging to the specific classification as the first peripheral equipment based on the reception qualities (for example, reception electric field intensities) of the respective signals transmitted from the peripheral equipments belonging to the specific classification connected to the plurality of docking devices, and establishes the radio communication link with the first peripheral equipment.

Therefore, when transaction equipment 100 is operated in cooperation with the peripheral equipment (for example, receipt printer 300) used in at least one target procedure of the merchandise registration application and the settlement application, since transaction equipment 100 can easily cooperate with the peripheral equipment to be used which is geographically disposed in the proximity of transaction equipment 100, the docking device connected this peripheral equipment and another peripheral equipment connected to this docking device while the salesperson holds transaction equipment 100 without the attachment of transaction equipment to the docking device (for example, docking device 200) without requiring the complicated setting operation, it is possible to prevent degradation in customer service quality. Accordingly, transaction equipment 100 can prevent a decline in purchaser's eagerness to purchase or degradation in loss of sales opportunity of the store, and thus, it is possible to prevent a decrease in sales. Particularly, in the store that handles the card settlement, transaction equipment 100 can prevent a decrease in fee income of a service provider such as an acquirer related to the card settlement.

According to the program for causing transaction equipment 100 to perform a predetermined procedure, it is also possible to perform the same process as that of transaction equipment 100 not in transaction equipment 100 but in the external device by causing the external device (for example, a tablet terminal) to perform the procedure defined in the program. The predetermined procedure mentioned herein includes a process of receiving signals transmitted from the plurality of peripheral equipments belonging to the specific classification used in the settlement application or the business application, a process of selecting any one of the peripheral equipments belonging to the specific classification as the first peripheral equipments based on the reception qualities of the respective signals transmitted from the plurality of peripheral equipments, and a process of establishing the radio communication link with the selected first peripheral equipments.

Transaction equipment 100 transmits the signal for reception quality detection to the first peripheral equipment (for example, receipt printer 300), and establishes the radio communication link with the docking device (for example, docking device 200) connected to the first peripheral equipment and at least one peripheral equipment connected to this docking device in a case where the reception quality (for example, reception electric field intensity) of the signal for reception quality detection in the first peripheral equipment is equal to or greater than the predetermined value. Accordingly, transaction equipment 100 can easily perform radio communication with the first peripheral equipment geographically disposed in the proximity of transaction equipment 100, the docking device to which the first peripheral equipment is connected, and at least one peripheral equipment connected to this docking device in both cases of a case where the salesperson holds transaction equipment 100 and a case where the salesperson attaches transaction equipment 100 to the first docking device (for example, docking device 200).

Transaction equipment 100 detects the attachment and separation (detachment) to or from the docking device (for example, docking device 200) to which at least one peripheral equipment (for example, receipt printer 300) used in the settlement application or the business application is connected, and establishes the radio communication link with at least one peripheral equipment connected to docking device 200 in a case where the attachment of transaction equipment 100 to docking device 200 is detected.

Accordingly, when transaction equipment 100 is operated in cooperation with the peripheral equipment (for example, receipt printer 300) used in at least one target procedure of the merchandise registration application and the settlement application, since transaction equipment 100 can easily cooperate with the peripheral equipment to be used which is connected to the docking device (for example, the most recently attached docking device) geographically disposed in the proximity of transaction equipment 100 with a simple operation of attaching transaction equipment 100 to the docking device (for example, docking device 200) without requiring the complicated setting operation, it is possible to prevent degradation in customer service quality. After the link with the peripheral equipment to be used which is connected to the docking device is established, even through the salesperson detaches transaction equipment 100 from docking device 200, since the radio communication link is maintained, transaction equipment 100 can perform the radio communication with the peripheral equipment similarly in both states of a state in which the salesperson holds transaction equipment 100 and a state in which the salesperson attaches the transaction equipment to docking device 200. Accordingly, since transaction equipment 100 can reduce a time required to establish the radio communication link with the simple operation of the salesperson, it is possible to prevent a decline in purchaser's eagerness to purchase or degradation in loss of sales opportunity of the store, and thus, it is possible to prevent a decrease in sales. Particularly, in the store that handles the card settlement, transaction equipment 100 can prevent a decrease in fee income of a service provider such as an acquirer related to the card settlement.

According to the program for causing transaction equipment 100 to perform a predetermined procedure, it is also possible to perform the same process as that of transaction equipment 100 not in transaction equipment 100 but in the external device by causing the external device (for example, a tablet terminal) to perform the procedure defined in the program. The predetermined procedure mentioned herein includes a process of detecting the attachment and separation of the transaction equipment to the docking device to which at least one peripheral equipment used in the settlement application or the business application is connected, and a process of establishing a radio communication link with at least one peripheral equipment connected to docking device 200 in a case where the attachment of transaction equipment 100 to docking device 200 is detected.

In a case where a radio communication link with another peripheral equipment which is not connected to the docking device (for example, docking device 200) is established, transaction equipment 100 cancels the radio communication link with the another peripheral equipment, and then establishes a radio communication link with at least one peripheral equipment connected to docking device 200. Accordingly, transaction equipment 100 can perform radio communication with high quality with only peripheral equipment connected to the geographically close docking device 200 after the radio communication with the peripheral equipment which is not geographically close to the transaction equipment becomes disabled with a simple operation of attaching transaction equipment 100 to the docking device (for example, docking device 200).

Transaction equipment 100 detects the proximity to the docking device (for example, docking device 200) to which at least one peripheral equipment (for example, receipt printer 300) used in the settlement application or the business application is connected, and establishes the radio communication link with at least one peripheral equipment connected to docking device 200 in a case where the proximity of transaction equipment 100 to docking device 200 is detected.

Accordingly, when transaction equipment 100 is operated in cooperation with the peripheral equipment (for example, receipt printer 300) used in at least one target procedure of the merchandise registration application and the settlement application, since transaction equipment 100 can easily cooperate with the peripheral equipment to be used which is connected to the docking device (for example, the most recently attached docking device) geographically disposed in the proximity of transaction equipment 100 with a simple operation of bringing transaction equipment 100 into close proximity with the docking device (for example, docking device 200) without requiring the complicated setting operation, it is possible to prevent degradation in customer service quality. After the link with the peripheral equipment to be used which is connected to the docking device is established, even though the salesperson separates transaction equipment 100 from docking device 200, since the radio communication link is maintained, transaction equipment 100 can perform the radio communication with the peripheral equipment similarly in both states of a state in which the salesperson holds transaction equipment 100 and a state in which the salesperson attaches the transaction equipment to docking device 200. Accordingly, since transaction equipment 100 can reduce a time required to establish the radio communication link with the simple operation of the salesperson, it is possible to prevent a decline in purchaser's eagerness to purchase or degradation in loss of sales opportunity of the store, and thus, it is possible to prevent a decrease in sales. Particularly, in the store that handles the card settlement, transaction equipment 100 can prevent a decrease in fee income of a service provider such as an acquirer related to the card settlement.

According to the program for causing transaction equipment 100 to perform a predetermined procedure, it is also possible to perform the same process as that of transaction equipment 100 not in transaction equipment 100 but in the external device by causing the external device (for example, a tablet terminal) to perform the procedure defined in the program. The predetermined procedure mentioned herein includes a process of detecting the proximity of the transaction equipment to docking device 200 to which at least one peripheral equipment used in the settlement application or the business application is connected, and a process of establishing a radio communication link with at least one peripheral equipment connected to docking device 200 in a case where the proximity of transaction equipment 100 to docking device 200 is detected.

In a case where a radio communication link with another peripheral equipment which is not connected to the docking device (for example, docking device 200) is established, transaction equipment 100 cancels the radio communication link with the another peripheral equipment, and then establishes a radio communication link with at least one peripheral equipment connected to docking device 200. Accordingly, transaction equipment 100 can perform radio communication with high quality with only peripheral equipment connected to the geographically close docking device 200 after the radio communication with the peripheral equipment which is not geographically close to the transaction equipment becomes disabled with a simple operation of bringing transaction equipment 100 into close proximity with the docking device (for example, docking device 200).

Transaction equipment 100 establishes a radio communication link with preset peripheral equipment (for example, common printer Ptr0) capable of being shared by the plurality of transaction equipments including own equipment (that is, transaction equipment 100). Thus, transaction equipment 100 performs radio communication with preset common printer Ptr0 which is not influenced by the geographical distance condition (for example, whether or not the transaction equipment is connected to the most recently attached or held docking device) or the reception quality (for example, reception electric field intensity) for transmission and reception signals. Accordingly, even though there is the salesperson who holds transaction equipment 100 in a position separated from common printer Ptr0, transaction equipment 100 remotely instructs that the data in the application (for example, the inventory application) executed in transaction equipment 100 will be printed, and thus, it is possible to improve convenience when the salesperson operates the application.

Since transaction equipment 100 can display the notification that the establishment or cancellation of the radio communication link with the peripheral equipment is performed on internal display 34b, it is possible to allow the salesperson who holds transaction equipment 100 to visually and easily grasp whether or not the radio communication with the peripheral equipment is enabled.

Since transaction equipment 100 can display the notification that the establishment or cancellation of the radio communication link with the peripheral equipment is performed on the peripheral equipment, it is possible to allow the salesperson who holds transaction equipment 100 or the salesperson who handles the peripheral equipment to visually and easily grasp whether or not the radio communication with the peripheral equipment is enabled.

While the exemplary embodiments of the transaction processing system according to the present disclosure have been described with reference to the accompanying, the present disclosure is not limited to the exemplary embodiments. It will be apparent to those skilled in the art that various changes, modifications, substitutions, additions, deletions and their equivalents may be made without departing from the claims, and would fall within the technical scope of the present disclosure.

It has been described in the above-described present exemplary embodiment that a settlement process using a credit card (more specifically, a magnetic credit card, connect IC credit card, or non-contact IC credit card) is used as an example of a card transaction of a purchaser, but the present disclosure is not limited to the settlement process using the credit card. For example, the present disclosure may be applied to a settlement process using a debit-card, electronic money, a prepaid card, a postpaid card, a point card, an electronic coupon, an electronic merchandise certificate or cash.

1. Transaction equipment comprising:
an application controller that is capable of executing at least one of a settlement application and a business application;
a radio communicator that performs communication with at least one peripheral equipment used in the settlement application or the business application or a docking device to which the at least one peripheral equipment is connected; and
a link establisher that selects any one of a plurality of docking devices, as a first docking device, based on reception qualities of signals transmitted from the plurality of docking devices, and establishes a radio communication link with the least one peripheral equipment connected to the first docking device.

2. The transaction equipment according to claim 1,
wherein the radio communicator transmits a signal for reception quality detection to the first docking device, and
the link establisher establishes a radio communication link with at least one peripheral equipment connected to the first docking device in a case where the reception quality of the signal for reception quality detection in the first docking device is equal to or greater than a predetermined value.

3. Transaction equipment comprising:
an application controller that is capable of executing at least one of a settlement application and a business application;
a radio communicator that performs communication with peripheral equipments belonging to a specific classification used in the settlement application or the business application or a docking device to which the peripheral equipment belonging to the specific classification is connected; and
a link establisher that selects any one of the peripheral equipments belonging to the specific classification, as first peripheral equipment, based on reception qualities of signals transmitted from the peripheral equipments belonging to the specific classification, which are connected to a plurality of the docking devices, and establishes a radio communication link with the first peripheral equipment.

4. The transaction equipment according to claim 3,
wherein the radio communicator transmits a signal for reception quality detection to the first peripheral equipment, and
the link establisher establishes radio communication links with the docking device connected to the first peripheral equipment and at least peripheral equipment connected to the docking device in a case where the reception quality of the signal for reception quality detection in the first peripheral equipment is equal to or greater than a predetermined value.

5. Transaction equipment comprising:
an application controller that is capable of executing at least one of a settlement application and a business application;
a radio communicator that performs communication with at least one peripheral equipment used in the settlement application or the business application;
an attachment and separation detector that detects the attachment and separation of the transaction equipment to and from the docking device to which the at least one peripheral equipment is connected; and
a link establisher that establishes a radio communication link with the at least one peripheral equipment,
wherein the link establisher establishes the link with the at least one peripheral equipment connected to the docking device in a case where the attachment of the transaction equipment to the docking device is detected by the attachment and separation detector.

6. The transaction equipment according to claim 5,
wherein, in a case where a radio communication link with another peripheral equipment that is not connected to the docking device to which the transaction equipment is attached is established, the link establisher cancels the radio communication link with the other peripheral equipment, and then establishes the link with the at least one peripheral equipment connected to the attached docking device.

7. Transaction equipment comprising:
an application controller that is capable of executing at least one of a settlement application and a business application;
a radio communicator that performs communication with at least one peripheral equipment used in the settlement application or the business application;
a proximity detector that detects the proximity of the transaction equipment to the docking device to which the at least one peripheral equipment is connected; and
a link establisher that establishes a radio communication link with the at least one peripheral equipment,
wherein the link establisher establishes the link with the at least one peripheral equipment connected to the docking device in a case where the proximity of the transaction equipment to the docking device is detected by the proximity detector.

8. The transaction equipment according to claim 7,
wherein, in a case where the transaction equipment establishes a radio communication link with another peripheral equipment which is not connected to the proximity docking device, the link establisher cancels the radio communication link with the other peripheral equipment, and then establishes the link with the at least one peripheral equipment connected to the proximity docking device.

9. The transaction equipment according to claim 1,
wherein the link establisher establishes a radio communication link with preset peripheral equipment capable of being shared by a plurality of the transaction equipments including own equipment.

10. The transaction equipment according to claim 1, further comprising:
a monitor that displays the notification that the establishment or cancellation of the radio communication link with the peripheral equipment is performed by the link establisher.

11. The transaction equipment according to claim 1,
wherein the radio communicator transmits a message indicating that the establishment or cancellation of the radio communication link between the transaction equipment and the peripheral equipment is performed by the link establisher to the peripheral equipment, and displays the message.

12. A transaction processing method in transaction equipment capable of executing at least one of a settlement application and a business application, the method comprising:
receiving signals transmitted from a plurality of docking devices to which at least one peripheral equipment used in the settlement application or the business application is connected;
selecting any one of the docking devices, as a first docking device, based on reception qualities of the signals transmitted from the plurality of docking devices; and
establishing a radio communication link with the at least one peripheral equipment connected to the selected first docking device.

13. A transaction processing method in transaction equipment capable of executing at least one of a settlement application and a business application, the method comprising:
receiving signals transmitted from a plurality of peripheral equipments belonging to a specific classification, which are used in the settlement application or the business application;
selecting any one of the peripheral equipments belonging to the specific classification, as first peripheral equipment, based on reception qualities of the signals transmitted from the plurality of peripheral equipments belonging to the specific classification; and
establishing a radio communication link with the selected first peripheral equipment.

14. A transaction processing method in transaction equipment capable of executing at least one of a settlement application and a business application, the method comprising:
detecting the attachment and separation of the transaction equipment to and from a docking device to which at least one peripheral equipment used in the settlement application or the business application is connected; and
establishing a radio communication link with the at least one peripheral equipment connected to the docking device in a case where the attachment of the transaction equipment to the docking device is detected.

15. A transaction processing method in transaction equipment capable of executing at least one of a settlement application and a business application, the method comprising:
detecting the proximity of the transaction equipment to the docking device to which at least one peripheral equipment used in the settlement application or the business application is connected; and
establishing a radio communication link with the at least one peripheral equipment connected to the docking device in a case where the proximity of the transaction equipment to the docking device is detected.
